(19) United States
(12) Patent Application Publication
(10) Pub. No.: US 2025/0323791 A1
(43) Pub. Date: Oct. 16, 2025

(54) Distributed Decryption

(71) Applicant: Cybernetica AS, Tallinn (EE)

(72) Inventors: Johanna Maria Kirss, Tallinn (EE); Nikita Snetkov, Tallinn (EE); Jelizaveta Vakarjuk, Tallinn (EE); Peeter Laud, Tallinn (EE)

(21) Appl. No.: 18/877,432

(22) PCT Filed: Jun. 14, 2023
(86) PCT No.: PCT/EP2023/066025

§ 371 Date: Dec. 20, 2024

(30) Foreign Application Priority Data
Jun. 21, 2022 (GB) 2209073.2

(51) Int. Cl. H04L 9/32; H04L 9/08

(52) U.S. Cl. CPC H04L 9/3221; H04L 9/0825; H04L 9/085; H04L 9/0869

(57) ABSTRACT

A method for distributed asymmetric decryption between a first party and a second party, each holding a different respective share of a secret key, is provided. The method comprises receiving, at the second party: a zero-knowledge proof of knowledge; and a plurality of inputs associated with a ciphertext to be decrypted, wherein the ciphertext is encrypted with a public key associated with the secret key. The method further comprises checking, by the second party, that the zero-knowledge proof of knowledge was generated based on the first party's share of the secret key; and, in response to determining that the zero-knowledge proof of knowledge was generated based on the first party's share of the secret key, sending, by the second party, information derived from the second party's share of the secret key. An example system for implementing the method is also provided. The system comprises a client device configured for performing distributed asymmetric decryption with a network device that holds a second share of a secret key, wherein the client device comprises a memory storing a first share of the secret key and wherein the client device is configured to act as the first party. The system further comprises the network device, which is configured to act as the second party.

### RELATED APPLICATION

The present application is a national stage application under 35 U.S.C. § 371 of International Application No. PCT/GB2023/066025, filed Jun. 14, 2023, and which claims priority from GB Patent Application No. 2209073.2 filed Jun. 21, 2022. The above-referenced applications are hereby incorporated by reference into the present application in their entirety.

### TECHNICAL FIELD

This disclosure describes mechanisms for distributed decryption between two or more parties.

### BACKGROUND

Distributed signing is a cryptographic process by which a cryptographic signature can only be applied to a document with the involvement of multiple parties. Distributed decryption is similarly a cryptographic process by which a document can only be decrypted with the involvement of multiple parties. As the reader will understand, distributed signing and decryption offer enhanced security. The secret key is shared by two or more parties, such that a single party can't sign or decrypt a document without the involvement of one or more additional parties.

In distributed signing, a document is formatted before the signing is performed. In distributed decryption, on the other hand, the formatting of the resulting plaintext is checked after the decryption has been performed. Distributed decryption may therefore have some attack scenarios that distributed signing does not have.

For satisfying stronger security requirements, such as security against chosen-ciphertext attacks (CCA), the decryption step of a distributed decryption process fails if the formatting is wrong, and the decryption can returns nothing besides a notification of failure. Where an adversary does not have a required share of the secret decryption key, it cannot distinguish between encryptions of different documents even if it has available a decryption functionality that it can apply to other ciphertexts.

Threshold Cryptosystems Secure against Chosen-Ciphertext Attacks by Pierre-Alain Fouque and David Pointcheval describes a first threshold cryptosystem secure against CCA that relies on the factorization problem and a second threshold cryptosystem secure against CCA based on the Rivest-Shamir-Adleman (RSA) model. Chosen-Ciphertext Security of Multiple Encryption by Yevgeniy Dodis and Jonathan Katz describes generic constructions of multiple-encryption schemes secure against CCA.

A problem, however, is that known distributed decryption approaches do not account for attacks arising from a parties to distributed decryption systems who are acting maliciously and in a less detectable manner. There exists a demand for a distributed decryption approach which improves security against such malicious parties to distributed decryption systems.

### SUMMARY

The present disclosure describes methods and devices which improve security of decryption in distributed decryption systems, and in particular which provide security against malicious parties to distributed decryption systems which are undetectable by known threshold decryption security schemes. In particular, the present disclosure improves security against malicious parties who have used offline guessing attacks to obtain a share of a secret decryption key, for example against chosen ciphertext attacks by malicious parties who have learned some shares of the secret decryption key.

For example, a malicious party may have learned partial information about some shares of the key, from the parties that are unable to offer proper protection to their key-shares. Using this partial information, and having a ciphertext that it wants to decrypt, the malicious party may make an educated guess, what these key-shares may be. Invoking the decryption protocol with honest parties, the malicious party may find out whether its guess was correct. Even if the guess was wrong, and the malicious party is unable to decrypt the ciphertext, the outcome adds to the malicious party's information about these shares of the key, and repeated invocation of the decryption protocol may allow the malicious party to narrow down to the single correct value of these shares.

One way of improving security is to avoid the offline attacks that an adversary may be able to do after they have obtained the encrypted secret key share from a device, where the encryption key has low entropy. The success of an offline attack does not necessarily mean that the adversary has recovered the secret key share, but it may also simply mean that the adversary can recognize that decryption is being performed correctly.

In a first aspect there is provided a computer-implemented method for distributed asymmetric decryption between a first party and a second party, each of the first and second parties holding a different respective share of a secret key, the method comprising: receiving, at the second party: (i) a zero-knowledge proof of knowledge; and (ii) a plurality of inputs associated with a ciphertext to be decrypted, wherein the ciphertext is encrypted with a public key associated with the secret key; checking, by the second party, that the zero-knowledge proof of knowledge was generated based on the first party's share of the secret key; and in response to determining that the zero-knowledge proof of knowledge was generated based on the first party's share of the secret key, sending, by the second party, information derived from the second party's share of the secret key.

The association between the public key and the secret key may be an asymmetric association. That is, the public key may be for encrypting the document, and the secret key may be used for decrypting the document. The keys may work in opposite cryptographic directions from one another. The public and secret keys may be part of an asymmetric cryptographic system.

Because the secret key is split between the first party's share and the second party's share, the first aspect relates to distributed decryption (for example threshold decryption). Herein, the secret key may be the product of the first party's share of the secret key and the second party's share of the secret key. Therefore, the first party's share of the secret key may be defined as the secret key divided by the second party's share of the secret key. Similarly, the second party's share of the secret key may be defined as the secret key divided by the first party's share of the secret key.

Because the zero-knowledge proof of knowledge was generated based on the first party's share of the secret key, the proofs allows the verifier to check that the party that generated the proofs knows the value of the first party's share of the secret key sk₁. In this example, the second party P2 verifies the proof received from the first party P1 in order to ascertain that the first party P1 knows its own share of the secret key sk₁. This mechanism allows the first party and the second party to generate and send verifiable statements of knowledge of a particular value to each other without revealing the value itself. Whenever a zero-knowledge proof of knowledge cannot be verified by a party, the party halts its operations and does not further interact with the proof generator. As the proof generator does not receive a reply from the verifying party, any malicious attempt to extract information from the party is prevented. This means that, along with protection from Chosen-Ciphertext Attacks (CCA), the system is also provided with a novel security mechanism to counter offline-guessing attacks.

The first aspect may be performed at a network computer device, for example a server or a client device. That is to say, the second party may be a network computer device, such as a server or a client device. The first party may be a client device in communication with the second party.

In a second aspect there is provided a network device configured for performing distributed asymmetric decryption with a client device holding a first share of a secret key, the network device comprising a memory storing a second share of the secret key, and being configured to: receive, from a client device: (i) a zero-knowledge proof of knowledge; and (ii) a plurality of inputs associated with a ciphertext to be decrypted, wherein the ciphertext is encrypted with a public key associated with the secret key; check that the zero-knowledge proof of knowledge was generated based on the first share of the secret key; and in response to determining that the zero-knowledge proof of knowledge was generated based on the first share of the secret key, send information derived from the second share of the secret key to the client device.

In the present disclosure, “network device” and “second party” are used interchangeably. Therefore, where a feature is described in connection to the network device, it is to be understood that the feature in question applies equally to the second party. Similarly, “client device” and “first party” are used interchangeably in the present disclosure.

The network device may comprise a storage device and at least one processor. The storage device may have instructions stored thereon which, when executed by the at least one processor, cause the at least one processor to perform the required steps.

In a third aspect there is provided a computer-readable medium (for example a non-transitory computer readable medium) having instructions stored thereon which cause at least one processor to execute a method according to the first aspect.

Optional features of the first, second and third aspects are described below.

The ciphertext may comprise at least three elements: a first element, comprising a generator of a cyclic group raised to the power of a randomly generated number within the size of the cyclic group; a second element, comprising an encryption of a plaintext based on the public key, a hashing function, and the randomly generated number; a third element, comprising a further zero-knowledge proof of knowledge which is based on the randomly generated number.

In one embodiment, the plurality of inputs associated with the ciphertext received at the second party may comprise the first, second and third elements of the ciphertext. This embodiment may correspond to FIG. 4 and the accompanying description below.

In an alternative embodiment with enhanced security, the plurality of inputs associated with the ciphertext received at the second party may comprise: a blinded version of the first element of the ciphertext, obtained by secretly picking and applying an exponent to mask the first element of the ciphertext; and a blinded proof obtained by malleating the non-interactive zero-knowledge proof of knowledge in the third element of the ciphertext. Malleating the proof in the third element of the ciphertext may include secretly picking and applying one or more exponents to mask one or more components of the proof. The blinded proof may be a designated-verifier, non-interactive zero-knowledge proof of knowledge. In particular, the proof may be also provided with an additional layer of encryption by applying a proof creation key during the malleation of the proof, so that the resulting blinded proof can only be verified using a proof verification key paired with the proof creation key. The second party may possess the proof verification key paired with the proof creation key and, therefore, may be the designated verifier of the blinded proof. Using the proof verification key, the second party may verify the blinded proof received from the first party. This embodiment may correspond to FIG. 5 and the accompanying description below.

One or more of the zero-knowledge proofs of knowledge disclosed herein may be a non-interactive zero-knowledge proof of knowledge. For example, every zero-knowledge proof of knowledge disclosed herein may be a non-interactive zero-knowledge proof of knowledge. This type of zero-knowledge proof requires no interaction between the prover and verifier. Therefore, using the non-interactive zero-knowledge proof over the interactive zero knowledge proof saves communication and data transfer overhead, as it does not require any interaction. Further, it allows one proof to be used for any number of verifiers without interacting with each verifier, thereby reducing the amount of proofs that need to be generated by a prover.

The network device may check that the further zero-knowledge proof of knowledge in the third element of the ciphertext pertains to the same randomly generated number as the first element and the second element of the ciphertext. This check ensures that the received ciphertext was not maliciously generated as part of a CCA. It involves verifying that the second element c, representing the encryption of the plaintext, was obtained using the same randomly generated number r also used for obtaining the first element u, rather than being handpicked as required in CCA.

The network device may, for example, compute a third value (β) by inputting: (i) the generator of the cyclic group, (ii) the first element of the ciphertext, (iii) the first value (α), and (iv) the second element of the ciphertext, into a random hashing function; and then check whether the generator of the cyclic group raised to the power of the second value (γ) equals a value obtained by multiplying the first value (α) by the first element of the ciphertext raised to the power of the computed third value (β).

The further zero-knowledge proof of knowledge may comprise: a first value (α) based on the generator of the cyclic group and the randomly generated number; and a second value (γ) based at least on the randomly generated number, a random hashing function, the generator of the cyclic group, the first value (α), and the first element of the ciphertext.

The information derived from the second party's share of the secret key may be calculated by applying the second party's share of the secret key sk₂ to the first element u of the ciphertext. This operation ensures that the value of the second party's share of the secret key sk₂ is never transmitted over the network, thereby introducing an additional safeguard in case the communication is intercepted or listened to by a malicious actor. For example, the information may be derived from the second party's share of the secret key by raising the first element u of the ciphertext to the power of the second party's share of the secret key sk₂.

The first party's share of the public key may be obtained by raising a generator of a cyclic group raised to the power of a value of the first party's share of the secret key. Determining that the zero-knowledge proof of knowledge was generated based on the first party's share of the secret key may serve to verify that the first party's share of the secret key is compatible with the first party's share of the public key.

Herein, the public key may be the product of the first party's share of the public key and the second party's share of the public key. Therefore, the first party's share of the public key may be defined as the public key divided by the second party's share of the public key. Similarly, the second party's share of the public key may be defined as the public key divided by the first party's share of the public key.

The first party's share of the public key may not itself be publicly known. However, the first party's share of the public key may be derivable from the public key and the second party's share of the public key.

Similarly, the second party's share of the public key may not itself be publicly known. The second party's share of the public key may be derivable from the public key and the first party's share of the public key.

Checking that the zero-knowledge proof of knowledge was generated based on the first party's share of the secret key may comprise: computing, at the second party, a fourth value (β′) by inputting: (i) the generator of the cyclic group, (ii) the first party's share of the public key, (iii) a fifth value (α′) included in the received proof of knowledge, into a random hashing function; checking whether the generator raised to the power of a received sixth value (γ′) included in the received proof of knowledge, equals: the product of the fifth value (α′) included in the received proof of knowledge, multiplied by the first party's share of the public key raised to the power of the computed fourth value (β′). Additionally, the computing of the fourth value (β′) may comprise further inputting: (iv) the first element of the ciphertext, (v) the second element of the ciphertext, and (vi) the third element of the ciphertext.

A party from which a zero-knowledge proof of knowledge was received may be blacklisted when it is determined that the zero knowledge proof of knowledge received from the party was not generated based on the first party's share of the secret key. For example, the first party may be blacklisted by the second party once a predetermined number of invalid zero-knowledge proofs of knowledge have been received by the second party from the first party.

The network device may generate a further zero-knowledge proof of knowledge based on the second party's share of the secret key; and send to the client computing device the further zero-knowledge proof of knowledge with the information derived from the second party's share of the secret key. The second party's share of the public key may be obtained, for example, by raising a generator of a cyclic group raised to the power of a value of the second party's share of the secret key. In one example, the further zero-knowledge proof of knowledge based on the second party's share of the secret key may be generated by: generating, at the second party, a random number within the size of the cyclic group;
computing a seventh value (α-u) by raising the first element of the ciphertext to the power of the generated random number; computing a eighth value (α-g) by raising the generator of the cyclic group to the power of the generated random number; computing a ninth value (β″) by inputting: (i) the first element of the ciphertext; (ii) the generator; (iii) the first element of the ciphertext raised to the power of the second party's share of the public key; (iv) the second party's share of the public key; (v) the seventh value (α-u); and (vi) the eighth value of (α-g), into a random hashing function; computing a tenth value (γ″) by multiplying the ninth value (β″) by the value of the second party's share of the secret key and subsequently adding the generated random value to it; wherein the seventh, eighth, ninth and tenth values comprise the further zero-knowledge proof of knowledge.

In a fourth aspect there is provided a computer-implemented method for distributed asymmetric decryption between a first party and a second party, each of the first and second parties holding a different respective share of a secret key, the method comprising: generating, by the first party, a zero-knowledge proof of knowledge based on the first party's share of the secret key; sending, by the first party: (i) the zero-knowledge proof of knowledge; and (ii) a plurality of inputs associated with a ciphertext to be decrypted, wherein the ciphertext is encrypted with a public key associated with the secret key; receiving, at the first party, information derived from the second party's share of the secret key; and generating, by the first party, a decryption of the ciphertext using the first party's share of the secret key and the received information.

The fourth aspect may be performed at a client device, such as a mobile device. That is to say, the first party may be a client device. The second party may be a network device in communication with the first party. As the reader will understand, the first party of the third aspect may be configured to operate in communication with the second party of the first aspect, so as to perform distributed decryption.

In a fifth aspect there is provided a client computing device, such as a mobile device, which is configured for performing distributed asymmetric decryption with a network device holding a second share of a secret key, the client computing device comprising a memory storing a first share of the secret key, and being configured to: generate a zero-knowledge proof of knowledge based on the first share of the secret key; send: (i) the zero-knowledge proof of knowledge; and (ii) a plurality of inputs associated with a ciphertext to be decrypted, wherein the ciphertext is encrypted with a public key associated with the secret key, to the network device; receive information derived from the second share of the secret key from the network device; and generate a decryption of the ciphertext using the first share of the secret key and the received information.

In the present disclosure, “client device” and “first party” are used interchangeably. Therefore, where a feature is described in connection to the client device, it is to be understood that the feature in question applies equally to the first party.

As the reader will understand, the client device of the fifth aspect may be configured to operate in communication with the network device of the second aspect, so as to perform distributed decryption.

The client device may comprise a storage device and at least one processor. The storage device may have instructions stored thereon which, when executed by the at least one processor, cause the at least one processor to perform the required steps.

In a sixth aspect there is provided a computer-readable medium (for example a non-transitory computer readable medium) having instructions stored thereon which cause at least one processor to execute a method according to the fourth aspect.

Optional features of the fourth, fifth and sixth aspects will now be described.

The information derived from the second party's share of the secret key may comprises the result of an operation in which the second party's share of the secret key is applied to an element of the ciphertext. For example, the information may be derived from the second party's share of the secret key by raising the first element of the ciphertext to the power of the second party's share of the secret key.

The ciphertext may comprise at least three elements: a first element, comprising a generator of a cyclic group raised to the power of a randomly generated number within the size of the cyclic group; a second element, comprising an encryption of a plaintext based on the public key, a hashing function, and the randomly generated number; a third element, comprising a further zero-knowledge proof of knowledge which is based on the randomly generated number. In one example, the further zero-knowledge proof of knowledge may comprise: a first value (α) based on the generator and the randomly generated number, and a second value (γ) based at least on the randomly generated number, a random hashing function, the generator, the first value (α), and the first element of the ciphertext.

In one embodiment, the plurality of inputs associated with the ciphertext sent by the first party may comprise the first, second and third elements of the ciphertext. This embodiment may correspond to FIG. 4 and the accompanying description below.

In an alternative embodiment with enhanced security, the plurality of inputs associated with the ciphertext sent by the first party may comprise: a blinded version of the first element of the ciphertext, obtained by secretly picking and applying an exponent to mask the first element of the ciphertext; and a blinded proof obtained by malleating the non-interactive zero-knowledge proof of knowledge in the third element of the ciphertext. Malleating the proof in the third element of the ciphertext may include secretly picking and applying one or more exponents to mask one or more components of the proof. The blinded proof may be a designated-verifier, non-interactive zero-knowledge proof of knowledge. In particular, the proof may be also provided with an additional layer of encryption by applying a proof creation key during the malleation of the proof, so that the resulting blinded proof can only be verified using a proof verification key paired with the proof creation key. The second party may possess the proof verification key paired with the proof creation key and, therefore, may be the designated verifier of the blinded proof. Using the proof verification key, the second party may verify the blinded proof received from the first party. This embodiment may correspond to FIG. 5 and the accompanying description below.

One or more of the zero-knowledge proofs of knowledge may be a non-interactive zero-knowledge proof of knowledge. For example, every zero-knowledge proof of knowledge may be a non-interactive zero-knowledge proof of knowledge.

The client computing device may check that the further zero-knowledge proof of knowledge in the third element of the ciphertext pertains to the same randomly generated number as the first element and the second element of the ciphertext. The client computing device may, for example, compute a third value (β) by inputting: (i) the generator of the cyclic group, (ii) the first element of the ciphertext, (iii) the first value (α), and (iv) the second element of the ciphertext, into a random hashing function; and then check whether the generator of the cyclic group raised to the power of the second value (γ) equals a value obtained by multiplying the first value (α) by the first element of the ciphertext raised to the power of the computed third value (β).

A first party share of the public key may be generated based on the first party's share of the secret key. The first party share of the public key may be used to generate the zero-knowledge proof of knowledge. The first party's share of the public key may be destroyed after use. For example, the first party's share of the public key may be generated responsive to receiving a request to decrypt the ciphertext and may be destroyed immediately after use.

Generating the zero-knowledge proof of knowledge based on the first party's share of the secret key may comprise generating two or more randomized values based on a generator of a cyclic group, the first party's share of the secret key, and the first party's share of the public key, using a randomly generated number and a random hashing function. The zero-knowledge proof of knowledge based on the first party's share of the secret key may be generated by: generating, at the first party, a random number within the size of a cyclic group; computing a fifth value (α′) by raising a generator of the cyclic group to the power of the generated random number; computing a fourth value (β′) by inputting: (i) the generator, (ii) the first party's share of the public key, (iii) the fifth value (α′), into a random hashing function; computing a sixth value (γ′) by multiplying the fourth value (β′) by the value of the first party's share of the secret key and subsequently adding the generated random value to it; wherein the fifth and sixth values comprise zero-knowledge proof of knowledge. Additionally, the computing of the fourth value (β′) may comprise further inputting: (iv) the first element of the ciphertext, (v) the second element of the ciphertext, and (vi) the third element of the ciphertext.

A decryption of the ciphertext may be generated using the first party's share of the secret key and the received information. The decryption may be obtained, for example, by generating a decryption of the second element of the ciphertext using a hashing function, the first party's share of the secret key, and the received information.

Before generating a decryption of the ciphertext using the first party's share of the secret key and the received information, the first party may receive a further zero-knowledge proof of knowledge and verifies that the received further proof of knowledge pertains to the second party's share of the secret key. The received zero-knowledge proof of knowledge may comprise, for example: (i) a seventh value (α-u), (ii) a eighth value (α-g), and (iii) a tenth value (γ″). The first party may check that the received proof of knowledge pertains to the second party's share of the secret key, for example, by: computing, at the first party, a ninth value (β″) by inputting: (i) the first element of the ciphertext; (ii) the generator; (iii) the first element of the ciphertext raised to the power of the second party's share of the public key; (iv) the second party's share of the public key; (v) the received seventh value (α-u); and (vi) the received eighth value (α-g), into a random hashing function; checking, at the first party: whether the first element of the ciphertext raised to the power of the received value of Gamma equals: the product of the received seventh value (α-u) multiplied by the second party's share of the public key raised to the power of the computed ninth value (β″); and whether the generator raised to the power of the received tenth value (γ″), equals: the product of the received seventh value (α-g) multiplied by the second party's share of the public key raised to the power of the computed ninth value (β″). The second party's share of the public key may be derived from the public key and the first party's share of the public key. In another embodiment, the first party generates a decryption of the ciphertext without verifying the further proof of knowledge. In yet another embodiment, the first party generates a decryption of the ciphertext without receiving any further proof of knowledge from the second party.

According to an embodiment, the further zero-knowledge proof of knowledge in the third element of the ciphertext may comprise a designated-verifier zero-knowledge proof of knowledge for the second party. The first party may hold an encryption key that encrypts information that can only be decrypted with a corresponding verification key. The second party may hold a verification key that decrypts information encrypted with a corresponding encryption key. Additionally, when generating or verifying the zero-knowledge proof of knowledge based on the first party's share of the secret key, both the first party and the second party may compute the fourth value (β′) by further inputting into the random hashing function: (iv) the first element of the ciphertext, and (v) the third element of the ciphertext.

### BRIEF DESCRIPTION OF THE DRAWINGS

The present disclosure will now be described in detail, with reference to the accompanying drawings, in which:

FIG. 1 is a schematic diagram showing an example overall system architecture, including a server and a client device, for performing distributed decryption according to the present disclosure;

FIG. 2 is a schematic diagram showing the client device from FIG. 1;

FIG. 3 is a schematic diagram showing the server device from FIG. 1;

FIG. 4 is a flow chart showing a distributed decryption process according to the present disclosure; and

FIG. 5 is a flow chart showing a distributed decryption process with additional privacy-preserving features according to the present disclosure;

FIG. 6 shows a schematic representation of a computer apparatus which can be used to perform methods described herein.

Like reference numerals are used for like components throughout the description and drawings.

### DETAILED DESCRIPTION

The present disclosure relates generally to improving security of decryption in distributed decryption systems, and in particular providing security against malicious parties to distributed decryption systems.

In distributed decryption systems, a secret key for performing decryption operations on ciphertext documents is distributed between two or more respective devices. Each device stores a respective share of the secret key. In order to decrypt a ciphertext document and thereby obtain the corresponding plaintext document, both shares of the secret key are needed. Therefore, a single device is not on its own able to decrypt the ciphertext document. In the present disclosure, we describe the principles of the present disclosure using two devices, each of which has a respective share of the secret key. However, as the reader will understand, the present disclosure could be implemented on any number of devices—for example three devices, four devices, or more, provided that each device has stored thereon a respective share of the secret key.

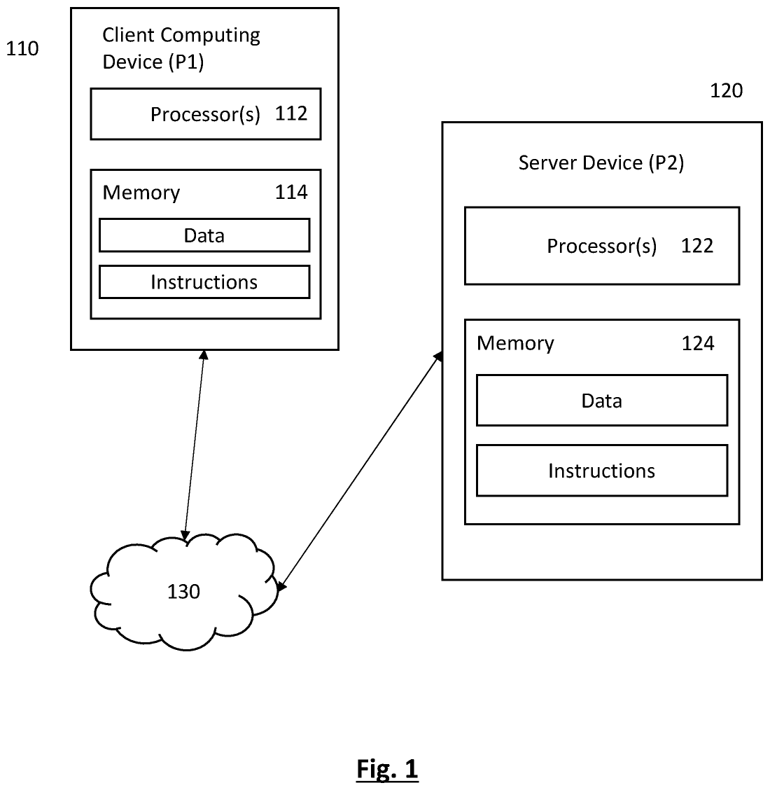

FIG. 1 shows an example of a system architecture for implementing the distributed decryption according to present disclosure. It includes a network device 120 and a client device 110, connected to one another over a network 130. The network device 120 has one or more processors 122 and a memory 124 storing data and instructions. The client device 110 has one or more processors 112 and a memory 114 storing data and instructions.

The network device 120 may typically be a server device. However, in some examples, the network device may be a client device similar to device 110. The client device 110 may be a mobile phone, a tablet device, a laptop, or a PC. Hereafter, the network device 120 will be referred to a server device 120 for simplicity, in order to clearly distinguish from the client device 110. However, the reader will understand that the scope of the present disclosure is not limited thereto.

The network connection 130 may be a wired connection, or a wireless connection. For example, the network connection may be a WWAN connection (e.g. a 2G, 3G, 4G, 4G LTE, or 5G cellular connection), or a WLAN connection (e.g. WiFi). Where devices 110 and 120 are both client devices, the connection may even be a near field connection, such as Bluetooth. As the reader will understand, this is a non-exhaustive list of possible connections between the devices 110, 120.

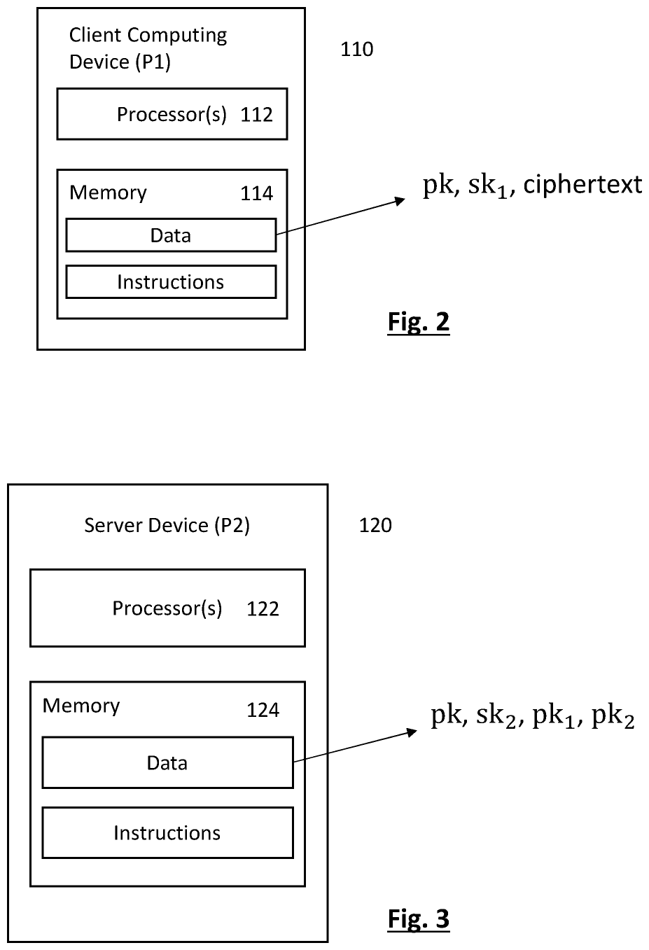

FIG. 2 shows the example client device 110 (sometimes referred to herein as party 1, or “P1”) in more detail. FIG. 3 shows the example server device 120 (sometimes referred to herein as party 2, or “P2”) in more detail. Data stored in the memory 124 of the server device 120 includes the full public key pk, the first party's share of the public key pk₁, the second party's share of the public key pk₂, and the second party's share of secret key sk₂. Data stored in the memory 114 of the client device 110 includes the full public key pk, the first party's share of secret key sk₁, and the ciphertext.

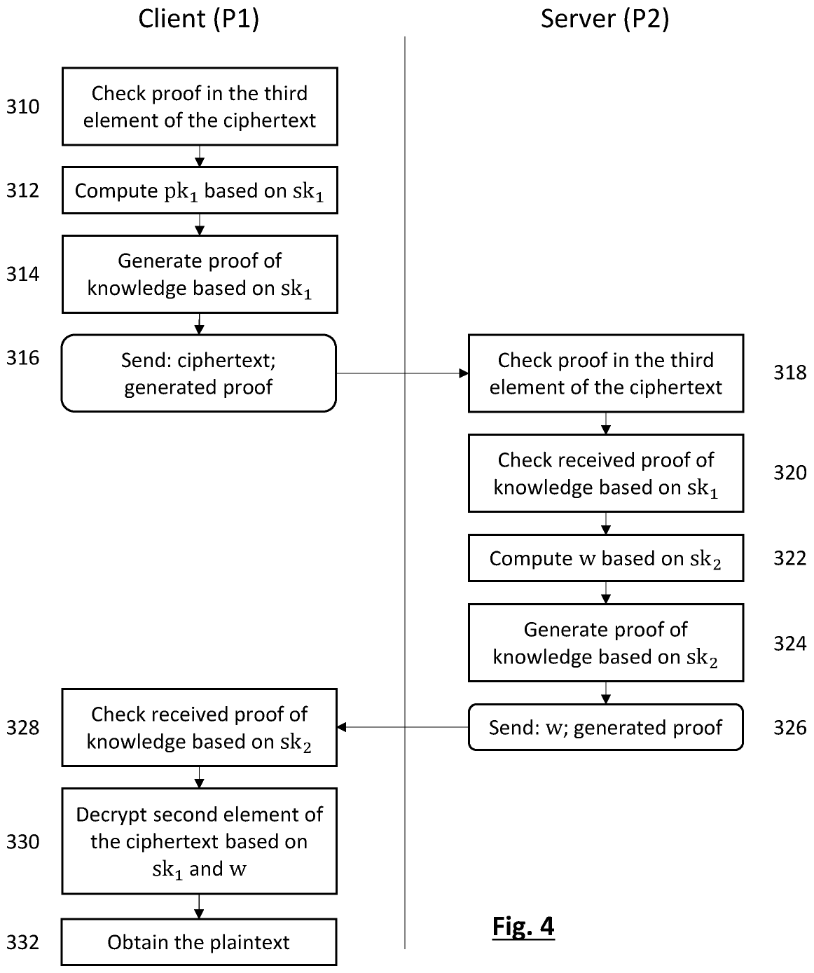

FIG. 4 is a flowchart showing an embodiment of the present disclosure. A series of operations are depicted in the flowchart involving client device 110 and server device 120. Client device 110 acts as the first party P1 to the method and server device 120 acts as the second party P2 to the method. A number of the operations include data transfers between client device 110 and server device 120 performed over the network 130.

The flowchart in FIG. 4 is an example method for decrypting a ciphertext according to the present disclosure. A ciphertext, also known as encrypted or encoded information, contains a form of a given original message that is unreadable by a human or a computer without the proper cipher to decrypt it. A cipher is an algorithm for performing encryption or decryption. Decryption, the inverse of encryption, is the process of turning a ciphertext into a readable message, known as plaintext.

The method makes use of non-interactive zero-knowledge proofs of knowledge of certain statements, in particular related to knowing certain discrete logarithms. Given a relation [symbol] ⊆ [symbol] × [symbol] , the equation π=NIZKPoK[w|x|x [symbol] w] denotes the proof that someone knows a value w∈W, such that the value x, known to the verifier of the proof, is related to w. The checking of this proof is denoted by check(π|x), which returns either true or false. In the example method of FIG. 4, NIZKPoK-s are used for the knowledge of discrete logarithms. These NIZKPoK-s come with associated data D, meaning that they are intended to be considered valid only within the scope of D. In turn, this means, that if someone tries to tamper with D, then this is noticed and the proof is considered invalid.

NIZKPoK-s are implemented with the use of random oracles. A random oracle H: [symbol] → [symbol] can be thought of as a random function. It is modelled as a box that takes queries x∈ [symbol] from anyone, and responds with elements of [symbol] . Internally, that box maintains the current partial mapping from [symbol] to [symbol] , extending it whenever it is queried with an x that it has not seen before. Implementations of random oracles are based on hash functions.

Let H₁ be a random oracle that takes any kinds of arguments (converted into bit-strings) into elements of [symbol] ₚ. The proof

$${NIZKPoK}^{D} [ {x}_{\vert}^{\vert} {g}_{1} , … , {g}_{k} , {h}_{1} , … , {h}_{k} \vert {∧}_{i = 1}^{k} {g}_{i}^{x} = {h}_{i} ]$$

is implemented as follows:
1. Randomly generate r∈ [symbol]
2. For each i, compute

$${α}_{i} ← {g}_{i}^{r}$$

3. Compute β=H₁ (g₁, . . . , gₖ, h₁, . . . , hₖ, αᵢ, . . . , αₖ, D)
4. Compute γ=r+βx
5. Output αᵢ, . . . , αₖ, γ

The verification of this NIZKPoK proceeds as follows:
1. Compute β=H₁ (g₁, . . . , gₖ, h₁, . . . , hₖ, αᵢ, . . . , αₖ, D)
2. For each i, check that

$${g}_{i}^{γ} = {α}_{i} \cdot {h}_{i}^{β} .$$

Equation i shows an algorithm corresponding to FIG. 4. The algorithm is the decryption protocol for a given ciphertext (u, c, π), wherein: u represents the value obtained from raising the generator g to the power of a randomly generated number r; c represents the encryption of the plaintext; π represents the zero-knowledge proof of knowledge based on the first element u. The algorithm uses hashing function H as random oracle for its proofs and returns the plaintext m.

```
    Data: pk, sk₁, and (u, c, π) (for P₁)
    Data: pk, sk₂, pk₁, pk₂, (for P₂)
    Result: the plaintext m (for P₁)
  1 P₁ does the following
  2 begin
  3 | check^{c}(π|g, u)
  4 | pk₁ ← g^{sk}^{₁} /* Cannot be stored in the phone */
  5 | π₂ ← NIZKPoK^{u,c,π}[sk₁ lg, pk₁ | g^{sk}^{₁} = pk₁]
  6 | Send u, c, π₂ to P₂
  7 P₂ does the following
  8 begin
  9 | check^{c}(π|g, u); check^{u,c,π} (π₂|g, pk₁)
10 | w ← u^{sk}^{₂}
11 | r ← NIZKPo[sk₂ | u, w, g, pk₂ | u^{sk}^{₂} = w Λ g^{sk}^{₂} = pk₂]
12 | Send w, τ to P₁
13 P₁ does the following
14 begin
15 | check(τ|u, w, g, pk/pk₁)
16 | Return c ⊕ H(u^{sk}^{₁} · w)
Equation i
```

FIG. 4 illustrates an example method between only two parties. The method may be performed by, for example, a client computing device 110 as the first party P1 and a server device 120 as the second party P2. The method may nevertheless involve two or more parties. For example, the method may involve a server device acting as the second party and one or more client computing devices behaving like the first party.

At operation 310, the client computing device 110 checks that the non-interactive zero-knowledge proof of knowledge in the third element of the ciphertext (i.e. element π of the ciphertext (u, c, π) from Equation i) is a zero-knowledge proof of knowledge based on the first element of the ciphertext (i.e. element u of the ciphertext (u, c, π) from Equation i). Operation 310 is implemented by line 3 of Equation i. The verification of this NIZKPoK proceeds as follows:
1. Compute β=H(g, u, α, c)
2. Check that g^{γ}=α·u^{β}

At operation 312, the client computing device 110 computes the first party's share of the public key pk₁ based on the first party's share of the secret key sk₁. Operation 312 is implemented by line 4 of Equation i. The first party's share of the public key pk₁ is computed by raising the generator g to the power of the first party's share of the secret key sk₁.

At operation 314, the client computing device 110 generates a zero-knowledge proof of knowledge π₂ based on the first party's share of the secret key sk₁. Operation 314 is implemented by line 5 of Equation i. The generation of non-interactive zero-knowledge proof of knowledge π₂ is implemented as follows:
1. Randomly generate r₁∈ [symbol] ₚ
2. Compute α₁←g^{r}^{₁}
3. Compute β₁=H(g, pk₁, α₁, u, c, π)
4. Compute γ₁=r₁+β₁ sk₁
5. Output α₁, γ₁

At operation 316, the client computing device 110 sends the ciphertext (u, c, π) and the generated zero-knowledge proof of knowledge π₂ to the server device 120 over the network 130. The server device 120 receives the ciphertext (u, c, π) and the generated zero-knowledge proof of knowledge π₂ from the client computing device 110. Operation 316 is implemented by line 6 of Equation i.

At operation 318, the server device 120 checks that the non-interactive zero-knowledge proof of knowledge in the third element of the ciphertext (i.e. element π of the ciphertext (u, c, π) from Equation i) is a zero-knowledge proof of knowledge based on the first element of the ciphertext (i.e. element u of the ciphertext (u, c, π) from Equation i). Operation 318 is implemented by the first check in line 9 of Equation i. The verification of this NIZKPoK proceeds as follows:
1. Compute β=H(g, u, α, c)
2. Check that g^{Y}=α·u^{β}

At operation 320, the server device 120 checks that the received zero-knowledge proof of knowledge π₂ is a zero-knowledge proof of knowledge based on the first party's share of the secret key sk₁. Operation 320 is implemented by the second check in line 9 of Equation i. The verification of this NIZKPoK proceeds as follows:

$$1. Compute {β}_{1} = H ( g , p {k}_{1} , {α}_{1} , u , c , π ) \\ 2. Check that {g}^{{γ}_{1}} = {α}_{1} \cdot p {k}_{1}^{{β}_{1}}$$

At operation 322, the server device 120 computes a value w based on the second party's share of the secret key sk₂. Operation 322 is implemented by line 10 of Equation i. The value assigned to the variable named w is obtained by raising the first element of the ciphertext (i.e. element u of the ciphertext (u, c, π) from Equation i) to the power of the second party's share of the secret key sk₂.

At operation 324, the server device 120 generates a zero-knowledge proof of knowledge τ based on the second party's share of the secret key sk₂. Operation 324 is implemented by line 11 of Equation i. The generation of non-interactive zero-knowledge proof of knowledge τ is implemented as follows:
1. Randomly generate r₂∈ [symbol] ₚ
2. Compute αᵤ←u^{r}^{₂}
3. Compute α_{g}←g^{r}^{₂}
4. Compute β₂=H(u, g, u^{pk}^{₂}, pk₂, αᵤ, α_{g})
5. Compute γ₂=r₂+β₂ sk₂
6. Output αᵤ, α_{g}, γ₂

At operation 326, the server device 120 sends the value w and the generated zero-knowledge proof of knowledge τ to the client computing device 110 over the network 130. The client computing device 110 receives the value w and the generated zero-knowledge proof of knowledge τ from the server device 120. Operation 326 is implemented by line 12 of Equation i.

At operation 328, the client computing device 110 checks that the received zero-knowledge proof of knowledge τ is a zero-knowledge proof of knowledge based on the second party's share of the secret key sk₂. Operation 328 is implemented by line 15 of Equation i. The verification of this NIZKPoK proceeds as follows:

$$1. Compute {β}_{2} = H ( u , g , {u}^{p {k}_{2}} , p {k}_{2} , {α}_{u} , {α}_{9} ) \\ 2. Check that {u}^{{γ}_{2}} = {α}_{u} \cdot p {k}_{2}^{{β}_{2}} \\ 3. Check that {g}^{{γ}_{2}} = {α}_{9} \cdot p {k}_{2}^{{β}_{2}}$$

The client computing device 110 derives the second party's share of the public key pk₂ from the public key pk and the first party's share of the public key pk₁. In particular, the second party's share of the public key pk₂ is obtained by dividing the public key pk by the first party's share of the public key pk₁.

At operation 330, the client computing device 110 generates a decryption of the second element of the ciphertext (i.e. element c of the ciphertext (u, c, π) from Equation i) based on the first party's share of the secret key sk₁ and the received value w. Operation 330 is implemented by line 16 of Equation i. The first element u of the ciphertext (u, c, π) is raised to the power of the first party's share of the secret key sk₁. The value resulting from this operation is then multiplied by the received value w, wherein w corresponds to the first element u of the ciphertext (u, c, π) raised to the power of the second party's share of the secret key sk₂. The product of the multiplication is then inputted into the hashing function H. Finally, the ciphertext c is decrypted by applying the ⊕ operation between c and the output of the hashing function H.

At operation 332, the client computing device 110 obtains the plaintext corresponding to the second element of the ciphertext (i.e. the plaintext corresponding to element c of the ciphertext (u, c, π) from Equation i). The plaintext m corresponds to the decryption of ciphertext c obtained in operation 330. The plaintext m contains the original message that was encrypted by the issuer of the ciphertext (u, c, π).

The setup for the cryptographic scheme used in the example of FIG. 4 and the algorithm in Equation i will now be described.

When using ElGamal encryption, a cyclic group [symbol] with a hard Decisional Diffie-Hellman (DDH) problem is used, e.g. some subgroup of the group of points of an elliptic curve. For example, let g be a generator of the group and p the number of elements in the group. Both g and p are known to all parties. Then, in this ElGamal encryption scheme, the secret key is a random value sk∈ [symbol] ₚ, where [symbol] ₚ denotes the set of integers modulo p. The corresponding public key is h=g^{sk}. Possible plaintexts will be elements of the cyclic group [symbol] . To encrypt a message m∈ [symbol] , the sender generates a random r∈ [symbol] ₚ and computes the ciphertext (c₁, c₂)=(g^{r}, m·h^{r}). To decrypt the ciphertext (c₁, c₂), the receiver must compute

$${c}_{1}^{sk}$$

and then find

$$m = {c}_{2} / {c}_{1}^{sk} .$$

In the example of FIG. 4 and the algorithm in Equation i, we use an alternate setting called hash-ElGamal encryption. Possible plaintexts are bit-strings of a given length n. In this case, a hash function H: [symbol] →{0, 1}ⁿ is used. The hash function is modelled after a random oracle, i.e. its outputs are perfectly random. To encrypt a message m∈{0,1}ⁿ, the sender generates a random r∈ [symbol] ₚ and computes the ciphertext (c₁, c₂)=(g^{r}, m⊕H(h^{r})). To decrypt the ciphertext (c₁, c₂), the receiver must compute

$${c}_{1}^{s k}$$

and then find

$$m = {c}_{2} ⊕ H ( {c}_{1}^{sk} ) .$$

As decryption is distributed, the public key may also be generated in a distributed manner. In an embodiment that includes k parties, each one of them selects a random skᵢ∈ [symbol] ₚ as their respective share skᵢ of the secret key sk. Each party then computes its public-key share pkᵢ=g^{a}^{ᵢ} and sends it to the other parties (or, alternatively, to a certification authority trusted by all parties to publish the public key pk). The product pk=g^{a}^{ᵢ} . . . g^{a}^{ₖ} is the public key. The corresponding secret key is sk=sk₁+ . . . +skₖ. However, the full secret key sk does not materialise at any point during the decryption process, thereby providing the distributed system with an additional safeguard in case of interceptions from malicious actors or other types of data breaches.

The decryption protocol between P1 and P2 given in Equation i relies on the assumption that the previous phases of Setup, Key Generation and Encryption have already been completed ahead of its execution. The Setup phase includes: the generation of cyclic group [symbol] using generator g with hard DDH problem; and the selection of hash function H: [symbol] →{0, 1}ⁿ modelled after a random oracle. In the Key Generation phase, P1 randomly selects sk₁∈ [symbol] ₚ and P2 randomly selects sk₂∈ [symbol] ₚ. The phone P1 stores only pk and sk₁. The phone does not store pk₁ to prevent malicious actors from verifying a guess of sk₁ by matching it against sk₁, in case of an interception or a data breach. The server P2 stores pk, sk₂ and may also store pk₁ and pk₂ for the purpose of speeding up its computations. During the Encryption phase, the random number r∈ [symbol] ₚ is generated and then used in both the first element u and second element c of the ciphertext (u, c, π). The third element It of the ciphertext is used to prove to both P1 and P2 that the same randomly generated r was used in the first and second elements of the ciphertext. The verification of π by either P1 or P2 provides protection from CCA, which rely on c being handpicked by the attacker. Once P1 has been provided with the ciphertext, the decryption protocol of Equation i may be initiated.

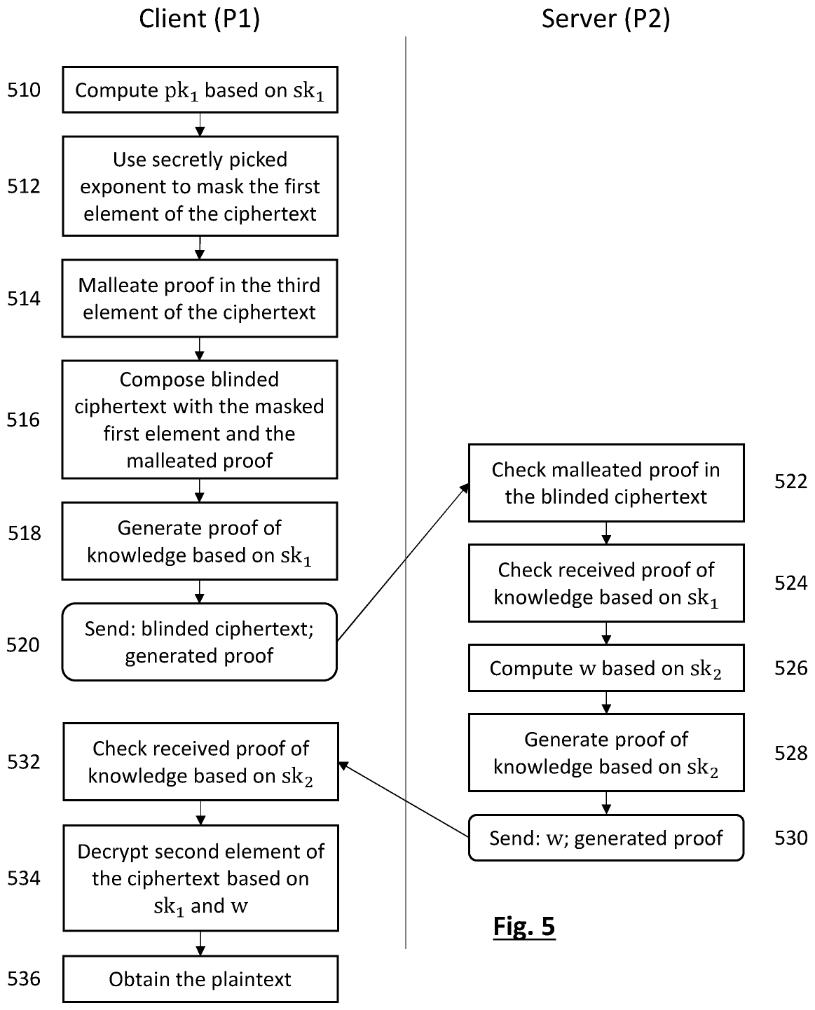

FIG. 5 is a flowchart showing a further embodiment according to the present disclosure. A series of operations are depicted in the flowchart involving client device 110 and server device 120. Client device 110 acts as the first party P1 to the method and server device 120 acts as the second party P2 to the method. A number of the operations include data transfers between client device 110 and server device 120 performed over the network 130.

The flowchart in FIG. 5 is a more elaborate example method for decrypting a ciphertext, and includes additional privacy-preserving features relative to the method of FIG. 4. In particular, in the example method of FIG. 5 the first party P1 only sends a blinded version of the ciphertext to the second party P2. The blinded ciphertext comprises a masked version of the first element u of the original ciphertext and a malleated version of the proof in the third element π of the original ciphertext, while the second element c of the original ciphertext is omitted altogether. This means that, not only does P2 never see the encrypted message itself (i.e. the second element of the original ciphertext), but potential listeners are also denied the opportunity to acquire it as it is not transmitted over network 130 for the duration of the protocol. Further, the remaining elements of the original ciphertext are only sent to P2 via network 130 in an altered form and the malleated proof is a designated-verifier proof that can only be verified by P2. Therefore, the combination of privacy-preserving techniques used in the example method of FIG. 5 results in every part of the original ciphertext being highly inaccessible to an attacker.

Equation j shows an algorithm corresponding to FIG. 5. The algorithm is the decryption protocol for a given ciphertext (u, c, π), wherein: u represents the value obtained from raising the generator g to the power of a randomly generated number r; c represents the encryption of the plaintext; π represents the zero-knowledge proof of knowledge based on the first element u. The algorithm uses hashing function H as random oracle for its proofs and returns the plaintext m. Unlike the algorithm of Equation i, in the algorithm shown in Equation j the third element π of the ciphertext appears as a string (α₁, Γ₁, Γ₂). Additionally, a proof creation key (ek, B₁, B₂) is used by P1 for generating a designated-verifier proof and a verification key (β, vk) is used by P2 for checking the proof.

```
    Data: pk, sk₁, (u, c, α₁, Γ₁, Γ₂), ek, B₁, B₂ (for P₁)
    Data: pk, sk₂, pk₁, pk₂, β, vk (for P₂)
    Result: the plaintext m (for P₁)
    P₁ does the following
  1 begin
  2 | pk₁ ←g^{sk}^{₁} /* Cannot be stored in the phone */
  3 | z [symbol] [symbol]     ₚ
  4 | u¹ ← u²
  5 | (α′₁, (Γ′₁, Γ′₂)) ← dvmall(g; u; (α₁, Γ₁, Γ₂)); z; (ek, B₁, B₂))
  6 | ((α₄, (α′′ᵣ, γ₄, g′′, h′′) ← mkPse′(g; pk₁; u′, α′₁, Γ′₁, Γ′₂)
  7 | u′, α′₁, Γ′₁, Γ′₂, g′′, α₄, α′′₄, γ₄, to P₂
    P₂ does the following
  8 begin
  9 | dvCkP2(g; u′; (α′₁, Γ′₁, Γ′₂)); vk, β)
10 | h′′ ← H(g, pk₁, α₄, u′, α′₁, Γ′₁, Γ′₂) /* Computed as by mkPse′ */
11 | ckPse′(g; pk₁; u′, α′₁, Γ′₁, Γ′₂; ((α₄, α′′₄), γ₄, g′′, h′′)
12 | w ← (u′)^{sk}^{₂}
13 | ((α₅₁, α₅₂), γ₅) ← mkP(u′, pk₁; w, pk; sk₂; empty)
14 | Send w, α₅₁, α₅₂, γ₅ to P₁
      P₁ does the following
15 begin
16 | ckP(u′, pk₁; w, pk; empty; ((α₅₁, α₅₂), γ₅))
        /* Destroy pk₁ */
17 | Return c ⊕ H(w^{sk}^{₁}^{/2}) /* z is inverted modulo p */
Algotrithm 29: Decryption (folded)
Equation j
```

FIG. 5 illustrates an example method between only two parties. The method may be performed by, for example, a client computing device 110 as the first party P1 and a server device 120 as the second party P2. The method may nevertheless involve two or more parties. For example, the method may involve a server device acting as the second party and one or more client computing devices behaving like the first party.

Before execution of the algorithm, the client computing device 110 may check that the non-interactive zero-knowledge proof of knowledge in the third element of the ciphertext (i.e. string (α₁, Γ₁, Γ₂) from Equation j) is a zero-knowledge proof of knowledge based on the first element of the ciphertext (i.e. element u of the ciphertext from Equation j).

At operation 510, the client computing device 110 computes the first party's share of the public key pk₁ based on the first party's share of the secret key sk₁. Operation 510 is implemented by line 2 of Equation j. The first party's share of the public key pk₁ is computed by raising the generator g to the power of the first party's share of the secret key sk₁.

At operation 512, the client computing device 110 randomly picks an exponent z, which is kept secret by P1 for the duration of the protocol, and applies z to the first element u of the ciphertext. Operation 512 is implemented by lines 3 and 4 of Equation j. The resulting u′, obtained by raising u to the power of z, is treated as a masked version of the first element u of the ciphertext.

At operation 514, the client computing device 110 malleates the proof in the third element (α₁, Γ₁, Γ₂) of the ciphertext. As part of this process, the proof is malleated using proof creation key ek, which is part of a keypair that includes proof creation key ek and proof verification key vk. The resulting malleated proof is therefore also a designated-verifier proof, i.e. it is only verifiable using the proof verification key vk. The proof verification key vk is a secret key held by P2. Operation 514 is implemented by line 5 of Equation j, where string

$$( {α}_{1}^{′} , {Γ}_{1}^{′} , {Γ}_{2}^{′} )$$

is the resulting designated-verifier malleated proof. The string

$$( {α}_{1}^{′} , {Γ}_{1}^{′} , {Γ}_{2}^{′} )$$

is obtained by malleating the proof in the third element (α₁, Γ₁, Γ₂) of the ciphertext as follows:

$$Compute {α}_{1}^{′} ← {α}_{1}^{z} \cdot {g}^{{z}^{1} mod p} , wherein {z}^{′} I ( ρ + 2 d + 2 κ ) . \qquad 1$$

$$Compute {Γ}_{1}^{′} ← {Γ}_{1}^{z} \cdot {ε}_{ek} ( {z}^{′} ) . \qquad 2$$

$$Compute {Γ}_{2}^{′} ← {Γ}_{2}^{z} \cdot {ε}_{ek} ( {z}^{′} ) . \qquad 3$$

$$Output ( {α}_{1}^{′} , {Γ}_{1}^{′} , {Γ}_{2}^{′} ) . \qquad 4$$

Here, I(ρ+2d+2κ) indicates the set of integers with a number of bits equal to ρ+2d+2κ. The value d corresponds to the number of bits for the size p of cyclic group [symbol] . Additionally, ρ and κ are fixed security parameters for soundness and privacy of the scheme. Typical values for these parameters are between 80 and 128 (or 256). It can normally be assumed that ρ≤κ≤d.

At operation 516, the client computing device 110 composes a blinded version of the ciphertext using the masked first element u′ and the designated-verifier malleated proof. Notably, the second element c of the original ciphertext does not feature in the blinded version. Operation 516 is a conceptual step that is useful for understanding the following steps in the algorithm of Equation j and therefore the operation itself does not appear in the pseudocode. The resulting blinded ciphertext appears in line 7 of Equation j as string

$$( {u}^{′} , {α}_{1}^{′} , {Γ}_{1}^{′} , {Γ}_{2}^{′} ) .$$

At operation 518, the client computing device 110 generates a non-interactive zero-knowledge proof of knowledge π₂ based on the first party's share of the secret key sk₁. Operation 518 is implemented by line 6 of Equation j, where proof π₂ is generated in the form of proof string

$$( {g}^{″} , {α}_{4} , {α}_{4}^{″} , {γ}_{4} )$$

as follows:

$$Randomly generate {r}_{4} {p}_{} . \qquad 1$$

$$Compute {α}_{4} ← {g}^{{r}_{4}} . \qquad 2$$

$$Compute {h}^{″} ← {H}_{3} ( g , p {k}_{1} , {α}_{4} , {u}^{′} , {α}_{1}^{′} , {Γ}_{1}^{′} , {Γ}_{2}^{′} ) , where {h}^{″} ∈ 𝔾 . \qquad 3$$

$$Compute {g}^{″} ← {( {h}^{″} )}^{1 / {sk}_{1}} . \qquad 4$$

$$Compute {α}_{4}^{″} ← {( {g}^{″} )}^{{r}_{4}} . \qquad 5$$

$$Compute {β}_{4} ← {H}_{4} ( g , {g}^{″} , p {k}_{1} , {h}^{″} , {α}_{4} , {α}_{4}^{″} , {u}^{′} , {α}_{1}^{′} , {Γ}_{1}^{′} , {Γ}_{2}^{′} ) , where {β}_{4} ∈ {ℤ}_{p} . \qquad 6$$

$$Compute {γ}_{4} ← {r}_{4} + {β}_{4} \cdot {sk}_{1} . \qquad 7$$

$$Output ( {g}^{″} , {α}_{4} , {α}_{4}^{″} , {γ}_{4} ) . \qquad 8$$

At operation 520, the client computing device 110 sends the blinded ciphertext

$$( {u}^{′} , {α}_{1}^{′} , {Γ}_{1}^{′} , {Γ}_{2}^{′} )$$

and the generated proof string

$$( {g}^{″} , {α}_{4} , {α}_{4}^{″} , {γ}_{4} )$$

to the server device 120 over the network 130. The server device 120 receives the ciphertext

$$( {u}^{′} , {α}_{1}^{′} , {Γ}_{1}^{′} , {Γ}_{2}^{′} )$$

and the generated proof string

$$( {g}^{″} , {α}_{4} , {α}_{4}^{″} , {γ}_{4} )$$

from the client computing device 110. Operation 520 is implemented by line 7 of Equation j.

At operation 522, the server device 120 checks that the received designated-verifier malleated proof

$$( {α}_{1}^{′} , {Γ}_{1}^{′} , {Γ}_{2}^{′} )$$

is a zero-knowledge proof of knowledge based on the first element of the ciphertext (i.e. element u of the ciphertext from Equation j). In order to verify the designated-verifier malleated proof, P2 must use its verification key (β, vk). Operation 522 is implemented by line 9 of Equation j. The verification of this proof proceeds as follows:
1. Check that

$${𝒟}_{vk} ( {Γ}_{1}^{′} ) = {𝒟}_{vk} ( {Γ}_{2}^{′} )$$

2. If check fails, the proof is rejected; if check passes, check that

$${α}_{1}^{′} \cdot {( {u}^{′} )}^{β} = {g}^{{𝒟}_{vk} ( {Γ}_{1}^{′} )}$$

3. If check fails, the proof is rejected; if check passes, the proof is accepted

At operation 524, the server device 120 checks that the received proof string

$$( {g}^{″} , {α}_{4} , {α}_{4}^{″} , {γ}_{4} ) ,$$

also known as proof π₂, is a non-interactive zero-knowledge proof of knowledge based on the first party's share of the secret key sk₁. Operation 524 is implemented by lines 10 and 11 of Equation j. The verification of this NIZKPoK proceeds as follows:

$$Compute {h}^{″} ← {H}_{3} ( g , p {k}_{1} , {α}_{4} , {u}^{′} , {α}_{1}^{′} , {Γ}_{1}^{′} , {Γ}_{2}^{′} ) . \qquad 1$$

$$Compute {β}_{4} ← {H}_{4} ( g , {g}^{″} , p {k}_{1} , {h}^{″} , {α}_{4} , {α}_{4}^{″} , {u}^{′} , {α}_{1}^{′} , {Γ}_{1}^{′} , {Γ}_{2}^{′} ) . \qquad 2$$

$$Compute that {g}^{{γ}_{4}} = {α}_{4} \cdot p {k}_{1}^{{β}_{4}} . \qquad 3$$

4. If check fails, the proof is rejected; if check passes, check that

$${( {g}^{′′} )}^{{γ}_{4}} = {α}_{4}^{′′} \cdot {( {h}^{′′} )}^{{β}_{4}}$$

5. If check passes, the proof is accepted

At operation 526, the server device 120 computes a value w based on the second party's share of the secret key sk₂. Operation 526 is implemented by line 12 of Equation j, where the value assigned to the variable named w is obtained by raising the first element of the blinded ciphertext (i.e. the masked first element u′ of the ciphertext from Equation j) to the power of the second party's share of the secret key sk₂.

At operation 528, the server device 120 generates a non-interactive zero-knowledge proof of knowledge τ based on the second party's share of the secret key sk₂. Operation 528 is implemented by line 13 of Equation j, where proof τ is generated in the form of proof string (α₅₁, α₅₂, α₅) as follows:

$$Randomly generate {r}_{5} {p}_{} . \qquad 1$$

$$Compute {α}_{51} ← {( {u}^{′} )}^{{r}_{5}} . \qquad 2$$

$$Compute {α}_{52} ← p {k}_{1}^{{r}_{5}} . \qquad 3$$

$$Compute {β}_{5} ← {H}_{5} ( {u}^{′} , p {k}_{1} , w , pk , {α}_{51} , {α}_{52} ) , where {β}_{5} ∈ {ℤ}_{p} . \qquad 4$$

$$Compute {γ}_{5} ← {r}_{5} + {β}_{5} \cdot {sk}_{2} . \qquad 5$$

$$Output ( {α}_{51} , {α}_{52} , {γ}_{5} ) . \qquad 6$$

At operation 530, the server device 120 sends the value w and the generated proof string (α₅₁, α₅₂, γ₅) to the client computing device 110 over the network 130. The client computing device 110 receives the value w and proof string (α₅₁, α₅₂, α₅) from the server device 120. Operation 530 is implemented by line 14 of Equation j.

At operation 532, the client computing device 110 checks that the received proof string (α₅₁, α₅₂, α₅), also known as proof τ, is a non-interactive zero-knowledge proof of knowledge based on the second party's share of the secret key sk₂. Operation 532 is implemented by line 16 of Equation j. The verification of this NIZKPoK proceeds as follows:
1. Compute β₅←H₅(u′, pk₁, w, pk, α₅₁, α₅₂)
2. Check that (u′)^{γ}^{₅}=α₅₁·w^{β}^{₅}
3. If check fails, the proof is rejected; if check passes, check that

$$p {k}_{1}^{{γ}_{5}} = {α}_{52} \cdot p {k}^{{β}_{5}}$$

4. If check passes, the proof is accepted

At operation 534, the client computing device 110 generates a decryption of the second element of the original ciphertext (i.e. element c of the ciphertext from Equation j) based on the first party's share of the secret key sk₁ and the received value w. Operation 534 is implemented by line 17 of Equation j. The received value w is raised to the power of the first party's share of the secret key sk₁ divided by exponent z. The value resulting from this operation is then inputted into the hashing function H. Finally, the ciphertext c is decrypted by applying the ⊕ operation between c and the output of the hashing function H.

At operation 536, the client computing device 110 obtains the plaintext corresponding to the second element of the original ciphertext (i.e. the plaintext corresponding to element c of the ciphertext from Equation j). The plaintext m contains the message that was encrypted by the issuer of the original ciphertext.

The resulting protocol is given in Equation k, which unfolds all the operations shown in Equation j. The protocol featured in Equation k is the same scheme given in Equation j, but it is simply shown in full by listing every step explicitly thereby removing calls to subroutines.

```
    Data: pk, sk₁, (u, c, α₁, Γ₁, Γ₂), ek (for P₁)
    Data: pk, sk₂, pk₁, pk₂, β, vk (for P₂)
    Result: the plaintext m (for P₁)
    P₁ does the following
  1 begin
  2 | pk₁ ← g^{sk}^{₁} /* Cannot be stored in the phone */
  3 | z [symbol] [symbol]     ₚ and z′ [symbol]   I(p + 2d + 2κ)
  4 | u¹ ← u′ and α′₁ ← α′ₜ - g [symbol]
  5 | Γ′₁ ← Γ′₂ · εₑₖ (z′) and Γ′₂ ← Γ′₂ · εₑₖ (z′)
  6 | rₛ [symbol] [symbol]     ₚ
  7 | αₛ ← g [symbol]
  8 | h′′ ← H₃(g, pk₁, αₛ, u′, α′₁, Γ′₁, Γ′₂), where h′′ ∈ [symbol]
  9 | g′′ ← (h′′)^{t/sk}^{₁}
10 | α′′₄ ← (g′′) [symbol]
11 | β₄ ← H₄(g, g′′, pk₁, h′′, α₂, α′′₄, u′, α′₁, Γ′₁, Γ′₂), where β₄ ∈ [symbol]   ₚ
12 | γ₁ ← r₄ + β₄ · sk₁
13 | Send u′, α′₁, Γ′₁, Γ′₂, g′′, α₄, α′′₄, γ₄ to P₂
    P₂ does the following
14 begin
15 | γ ← [symbol] [symbol]     (Γ′₁)
16 | check that γ = [symbol] [symbol]     (Γ′₂)
17 | check that α′₁, · (u′)^{d} = g^{γ}
18 | h′′ ← H₃(g, pk₁, α₄, u′, α′₁, Γ′₁, Γ′₂)
19 | β₄ ← H₄(g, g′′, pk₁, h′′, α₄, α′′₄, u′, α′₁, Γ′₁, Γ′₂)
20 | Check that g^{γ4} = α₄ · pk₁^{β4} and (g′′)^{γ4} = α′′₄ · (h′′)^{^{β}}⁴
21 | w ← (u′)^{sk}^{₂}
22 | rₛ [symbol] [symbol]     ₚ
23 | αₛ₁ ← (u′)^{rs}
24 | αₛ₂ ← pk₁^{rs}
25 | βₛ ← H₃(u′, pk₁, w, pk, αₛ₁, αₛ₂), where β₆ ∈ [symbol]   ₚ
26 | γ_{b} ← rₛ + βₛ · skₛ
27 | send w, αₛ₁, αₛ₂, γₛ to P₁
    P₁ does the following
28 begin
29 | βₛ ← H₃(u′, pk₁, w, pk, αₛ₁, αₛ₂)
30 | Check that (u′)^{γs} = αₛ₁ · w^{ks} and pk₁^{sk} = αₛ₂ · pk^{sk}
    /* Destroy pk₁ */
31 | Return c ⊕ H(w^{sk}^{₁}^{/2}) /* z is inverted modulo p */
Algotrithm 3: Decryption
Equation k: unfolded algorithm of Equation j.
```

[symbol]

indicates data missing or illegible when filed

The setup for the cryptographic scheme used in the example of FIG. 5 and the algorithm in Equation j will now be described. The ElGamal scheme is used for encryption and decryption. When using ElGamal encryption, a cyclic group [symbol] with a hard Decisional Diffie-Hellman (DDH) problem is used, e.g. some subgroup of the group of points of an elliptic curve. For example, let g be a generator of the group and p the number of elements in the group. Both g and p are known to all parties. Then, in this ElGamal encryption scheme, the secret key is a random value sk∈ [symbol] ₚ, where [symbol] ₚ denotes the set of integers modulo p. The corresponding public key is h=g^{sk}. Possible plaintexts will be elements of the cyclic group [symbol] . To encrypt a message m∈ [symbol] , the sender generates a random r∈ [symbol] ₚ and computes the ciphertext (c₁, c₂)=(g^{r}, m·h^{r}). To decrypt the ciphertext (c₁, c₂), the receiver must compute

$${c}_{1}^{sk}$$

and then find

$$m = {c}_{2} / {c}_{1}^{sk} .$$

In the example of FIG. 5 and the algorithm in Equation j, we use an alternate setting called hash-ElGamal encryption. Possible plaintexts are bit-strings of a given length n. In this case, a hash function H: [symbol] →{0, 1}ⁿ is used. The hash function is modelled after a random oracle, i.e. its outputs are perfectly random. To encrypt a message m∈{0, 1}ⁿ, the sender generates a random r∈ [symbol] ₚ and computes the ciphertext (c₁, c₂)=(g^{r}, m⊕H(h^{r})). To decrypt the ciphertext (c₁, c₂), the receiver must compute

$${c}_{1}^{sk}$$

and then find

$$m = {c}_{2} ⊕ H ( {c}_{1}^{sk} ) .$$

As decryption is distributed, the public key may also be generated in a distributed manner. In an embodiment that includes 2 parties, each one of them selects a random skᵢ∈ [symbol] ₚ as their respective share skᵢ of the secret key sk. Each party then computes its public-key share pkᵢ=g^{a}^{ᵢ} and sends it to the other parties (or, alternatively, to a certification authority trusted by all parties to publish the public key pk). In this privacy-preserving variant of the scheme, the public key is defined as pk=(g^{sk}^{₁})^{sk}^{₂}. The corresponding secret key is sk=sk₁·sk₂. Hence, the secret key is multiplicatively shared, not additively. However, the full secret key sk does again not materialise at any point during the decryption process, thereby still providing the distributed system with an additional safeguard in case of interceptions from malicious actors or other types of data breaches.

The decryption protocol between P1 and P2 given in Equation j relies on the assumption that the previous phases of Setup, Key Generation and Encryption have already been completed ahead of its execution.

The Setup phase includes: the generation of cyclic group [symbol] of size p (a prime number) using generator g with hard DDH problem; and the selection of hash function H: [symbol] →{0, 1}ⁿ modelled after a random oracle.

The size p of cyclic group [symbol] is d bits long. Further, two fixed security parameters ρ and κ are chosen for soundness and privacy of the scheme. Typical values for these parameters range between 80 and 128 (or 256), and it normally is assumed that ρ≤κ≤d.

Throughout the protocol, there are six different types of invocations to hash function H. These are denoted as H, H₁, H₂, H₃, H₄, H₅. Different invocations have different output types:
H returns a bit-string of the same length as the plaintext m
H₁ and H₃ return an element of [symbol]
H₂ returns an integer of length ρ
H₄ and H₅ return an element of [symbol] ₚ

In the Key Generation phase, Phone P1 randomly chooses sk₁∈ [symbol] ₚ and server P2 randomly chooses sk₂∈ [symbol] ₚ. Then, they send pk₁=g^{sk}^{₁} and pk₂=g^{sk}^{₂} to each other. Let

$$pk = {pk}_{1}^{{sk}_{2}} = {pk}_{2}^{{sk}_{1}} .$$

The phone P1 stores only pk and sk₁, the latter encrypted with a low-entropy symmetric key. The server P2 stores pk, sk₂, and, for speeding up its computations, also pk₁ and pk₂. The phone P1 may not store neither pk₁ nor pk₂, because a guess of sk₁ can be matched against either of them.

The private key of the system is shared multiplicatively, not additively. This is as confidentiality-preserving as additive sharing, because p—the size of the group [symbol] —is a prime number.

The server P2 also generates the DVNIZK key ((ek, B₁), (vk, β)), where β≤2^{ρ}, based on a homomorphic cryptosystem, and sends the public part to the phone P1. The server P2 computes a different encryption B₂=ϵₑₖ(β), and sends this one to the phone P1 as well. The server P2 then proves to the phone P1 that (ek, B₁) is correctly formed, and B₁ and B₂ encrypt the same plaintext. The proof of equality of plaintexts must make use of the random oracle H somehow. The phone P1 may sign (ek, B₁, B₂); let σ be the signature.

Without wishing to be bound by theory, a Paillier cryptosystem, or a Damgård-Jurik cryptosystem, may for example be used. Both Paillier cryptosystems, and Damgård-Jurik cryptosystems, are homomorphic. See, for example, Damgård [Ivan Damgård, Nelly Fazio, Antonio Nicolosi: “Non-interactive Zero-Knowledge from Homomorphic Encryption”. Proceedings of the Theory of Cryptography Conference (TCC) 2006: 41-59, Sec. 6], which is incorporated herein by reference.

As a result, the entire public key is (svk, pk, ek, B₁, B₂, σ). The phone P1 holds the private value sk₁. The server P2 holds the private values sk₂, vk, β.

During the Encryption phase, the random number r∈ [symbol] ₚ is generated and then used in both the first element u and second element c of the ciphertext (u, c, π). The third element π of the ciphertext is used to prove to both P1 and P2 that the same randomly generated r was used in the first and second elements of the ciphertext. The verification of π by either P1 or P2 provides protection from CCA, which rely on c being handpicked by the attacker. Once P1 has conducted initial checks on the original ciphertext, the decryption protocol of Equation j may be initiated.

The roles of our two parties are not identical: it is the phone P1 that initially obtains the ciphertext, and decides, when to decrypt it. For decryption, it requests the help of the assisting server P2. But when the phone P1 initially receives the ciphertext, it can already perform some checks on it, and forget some of the components of the ciphertext that are later not used in the decryption protocol.

```
  Data: public key svk:, pk, ek, B₁, B₂, σ and message m
  Result: The ciphertext encrypting m with pk
1 Check that σ is a signature to (ek, B₁, B₂) with svk /* Can do ahead of time */
2 r₀ [symbol] [symbol]      ₚ, r₁ [symbol]   I(p + d + κ), r₂ [symbol]    I(p + d + κ), r₃ [symbol]   I(2p + d + 2κ)
3 (u, c) ← (g [symbol]  , m ⊕ H(pk^{r0}))
4 Pick random coins r₁, r₂, r′₁ and r′₂ for homomorphic encryption
5 α₁ ← g^{r}^{₁}^{mod p} and Γ₁ ← ε_{ck}(r₁; r₁) · B₁^{r0} and Γ₂ ← ε_{ck}(r₁; r₁) · B₂^{r0}
6 g′ ← H₁(g, u, α₁, Γ₁, Γ₂, c), where g′ ∈ [symbol]
7 h′ ← (g′)^{r}^{₀}
8 α′₁ ← (g′)^{r}^{₁} ^{mod p}
9 α₂ ← g^{r}^{₂}^{mod p} and α₃ ← g^{r}^{₃} ^{mod p}
10 α′₂ ← (g′)^{r}^{₂}^{mod p} and α′₃ ← (g′)^{r}^{₃} ^{mod p}
11 A₁ ← ε_{ck}(r₃; r′₁) · B₁^{r}^{₂} and A₂ ← ε_{ck}(r₃; r′₂) · B₂^{r}^{₂}
12 β′ ← H₂(pk, ek, u, c, h′, α₁, α′₁, Γ₁, Γ₂, α₂, α′₂, α₃, α′₃, A₁, A₂), where β′ ∈ I(ρ)
13 γ₂ ← r₂ + β′ · r₀ and γ₃ ← r₃ + β′ · r₁
14 r′′₁ ← r′₁ [symbol]   (β′ [symbol]   r₁) and r′′₂ ← r′₂ [symbol]   (β′ [symbol]   r₂)
15 Return u, c, α₁, Γ₁, Γ₂, α′₁, h′, A₁, A₂, α₂, α′₂, α₃, α′₃, γ₂, γ₃, r′′₁, r′′₂
Algorithm 1: Encryption
Equation e
```

[symbol]

indicates data missing or illegible when filed

Given a public key (svk, pk, ek, B₁, B₂, σ), and a message m∈ [symbol] , perform the steps in the pseudocode shown in Equation e. In this algorithm, all values randomly generated from the sets I(k) for various bit-lengths k are thought of as integers, and the computations with them do not wrap around (wrap-arounds are explicit, using the mod operation). In Equation e, the outputs u and c are the ciphertext from the ElGamal encryption scheme. The outputs α₁, Γ₁ and Γ₂ are the DVNIZK proof for the assisting server P2, that someone knows the discrete logarithm of u. The value h′ makes this DVNIZK have simulatable exponents. The rest of the ciphertext is a NIZK proof (i.e. verifiable by anyone) that α₁, Γ₁, Γ₂ constitute this DVNIZK proof, and

$${α}_{1}^{′} , {h}^{′}$$

make it have simulatable exponents. Presenting this proof amounts to showing that the encryptor knows the values r₀ and r₁, such that

$$u = {g}^{{r}_{0}} , {h}^{′} = {( {g}^{′} )}^{{r}_{0}} , {g}^{{r}_{1}} = {α}_{1} , {( {g}^{′} )}^{{r}_{1}} = {α}_{1}^{′} , and {ℰ}_{ek} ( {r}_{1} ) \cdot {B}_{i}^{{r}_{0}} = {Γ}_{i} , where i ∈ \{ 1 , 2 \} .$$

The NIZK proof is generated by picking random r₂ and r₃ for hiding the values r₀ and r₁, committing to them by giving the values

$${α}_{3} , {α}_{3}^{′} and {A}_{2} ,$$

and showing that their random linear combinations work as expected.

```
  Data: public key svk, pk, ek, B₁, B₂, σ
  Data: ciphertext u, c, α₁, Γ₁, Γ₂, α′₁, h′, A₁, A₂, α₂, α′₂, α₃, α′₃, γ₂, γ₃, r′′₁, r′′₂
  Result: components of the ciphertext to be kept for decryption
1 g′ ← H₁(g, u, α₁, Γ₁, Γ₂, c), where g′ ∈ [symbol]
2 β′ ← H₂(pk, ek, u, c, h′, α₁, α′₁, Γ₁, Γ₂, α₂, α′₂, α₃, α′₃, A₁, A₂), where β′ ∈ I(ρ)
3 Check that α₂ · u^{β′} = g^{γ2} and α′₂ · (h′)^{β′} = (g′)^{γ2}
4 Check that α₃ · α₁^{β′} = g^{γ3} and α′₃ · (α′₁)^{β′} = (g′)^{γ3}
5 Check that ε_{ck}(γ₃; r′′₁) · B₁^{γ2} = A₁ · Γ₁^{β′} and ε_{ck}(γ₃; r′′₂) · B₂^{γ2} = A₂ · Γ₂^{β′}
6 Return u, c, α₁, Γ₁, Γ₂
Algorithm 2: Checks made by the phone, when receiving a ciphertext
Equation f
```

When the phone P1 receives the ciphertext, it can immediately check the NIZK proof that the DVNIZK proof is a good proof. The pseudocode in Equation f shows how the check is done. The algorithm returns only these components of the ciphertext that are needed for decryption according to Equation j.

The use of the DVNIZK proofs (α₁, Γ₁, Γ₂) is not the only manner in which proofs of knowledge of the exponent r can be malleated and privacy for P1 can be obtained. By introducing more complex cryptographic primitives, such as bilinear pairings, NIZK proofs can be malleated even without the need to designate a particular verifier.

In the bilinear pairings setting, three cyclic groups [symbol] ₁, [symbol] ₂, [symbol] _{T} of the same size p are used at the same time, where the decisional Diffie-Hellman problem is difficult in each group. In addition to the usual group operations in the three groups, there must exist an operation e that takes two arguments—one from [symbol] ₁ and one from [symbol] ₂—and returns an element of [symbol] _{T}. This operation e must be bilinear, i.e. for all elements g₁ and g₂ of [symbol] ₁, elements h₁ and h₂ of [symbol] ₂, and numbers x (in [symbol] ₚ), it must satisfy

$$e ( {g}_{1} \cdot {g}_{2}^{x} , {h}_{1} ) = e ( {g}_{1} , {h}_{1} ) \cdot {e ( {g}_{2} , {h}_{1} )}^{x} , and e ( {g}_{1} , {h}_{1} \cdot {h}_{2}^{x} , ) = e ( {g}_{1} , {h}_{1} ) \cdot {e ( {g}_{1} , {h}_{2} )}^{x} .$$

Also, the operation e must be non-degenerate, meaning that there should exist inputs, where the output of e is not the unit element of [symbol] _{T}. For example, the elements of the groups [symbol] ₁, [symbol] ₂ may be points on related elliptic curves, while [symbol] _{T} is a subgroup of the multiplicative group of a finite field. Without wishing to be bound by theory, Weil pairings, or Tate pairings, both of which involve elliptical curves usually over finite fields, may for example be used.

Groth-Sahai proofs [see Jens Groth and Amit Sahai: “Efficient non-interactive proof systems for bilinear groups”. EUROCRYPT 2008 proceedings, pages 415-432, which is incorporated herein by reference] are an example framework for constructing NIZK proofs about knowing the multiplicative relationships between elements of groups [symbol] ₁, [symbol] ₂, [symbol] _{T}. Groth-Sahai proofs are malleable with respect to certain operations [see Melissa Chase, Markulf Kohlweiss, Anna Lysyanskaya, and Sarah Meiklejohn: “Malleable proof systems and applications”. EUROCRYPT 2012 proceedings, pages 281-300, which is incorporated herein by reference]. For example, given a set of elements of [symbol] ₁, [symbol] ₂, [symbol] _{T} and a Groth-Sahai proof that these elements are in a certain relationship and/or the prover knows certain exponents that relate these elements, it is possible to introduce additional elements with certain relationships to existing ones, and perhaps remove some of the existing elements, and then modify the Groth-Sahai proof so that it also proves the relationships that hold for the newly introduced elements.

Taking the scheme whose decryption process is described in FIG. 4, we could use group [symbol] ₁ as the underlying group [symbol] of that scheme. In this case, we could use in place of the NIZK proof π (Equation i) a Groth-Sahai proof that someone knows the discrete logarithm of u. It is now possible for the party P1 to replace u with some u′=u^{z} for a random z (as in Equation j), and also change π into π′, such that the latter proves that someone knows the discrete logarithm of u′. Party P1 will then ask party P2 to apply the secret key share sk₂ onto u′, including π′ in its request

$$( instead of {α}_{1}^{′} , {Γ}_{1}^{′} , {Γ}_{2}^{′} ) .$$

Party P2 verifies π′ against u′.

The details of Groth-Sahai proofs and their malleability will now be described and applied to the use case of blinding a ciphertext. Let g be the generator of [symbol] ₁, and h be the generator of [symbol] ₂. Groth-Sahai proofs make use of a Common Reference String (CRS), which must have been generated beforehand by a trusted party, and may be shared by all instances of Groth-Sahai proofs. In this case, the CRS consists of elements [symbol] , [symbol] , [symbol] of [symbol] ₂, such that (h, [symbol] , [symbol] , [symbol] ) is a Diffie-Hellman tuple, i.e. logₕ [symbol] = [symbol] [symbol] . When the party performing the encryption has computed u=g^{r}, then it will construct the proof of knowledge of r in the following manner:
1. Generate random element s of [symbol] ₚ

$$2. Let {d}_{1} = {𝒰}^{r} \cdot {h}^{s}$$

$$3. Let {d}_{2} = {𝒱}^{r} \cdot {s}^{}$$

$$4. Let T = {g}^{s}$$

5. The proof π is (d₁, d₂, T). We see that d₁, d₂ are elements of G₂, while T is an element of G₁

In order to verify π (with respect to u), the verifier performs the following checks:
1. Check that e(g, d₁)=e(u, [symbol] )·e(T, h)
2. Check that e(g, d₂)=e(u, [symbol] )·e(T, [symbol] )

When party P1 wants to blind the value u and the proof π=(d₁, d₂, T), it will generate random elements z, y of [symbol] ₚ, and perform the following computations:

$$1. Let {u}^{′} = {u}^{z}$$

$$2. Let {d}_{1}^{′} = {d}_{1}^{z} \cdot {h}^{y}$$

$$3. Let {d}_{2}^{′} = {d}_{2}^{z} \cdot {y}^{}$$

$$4. Let {T}^{′} = {T}^{z} \cdot {g}^{y}$$

Now u′ is the blinded value, and

$$( {d}_{1}^{′} , {d}_{2}^{′} , {T}^{′} )$$

the blinded proof. The blinded proof is verified by performing exactly the same checks as for the original proof.

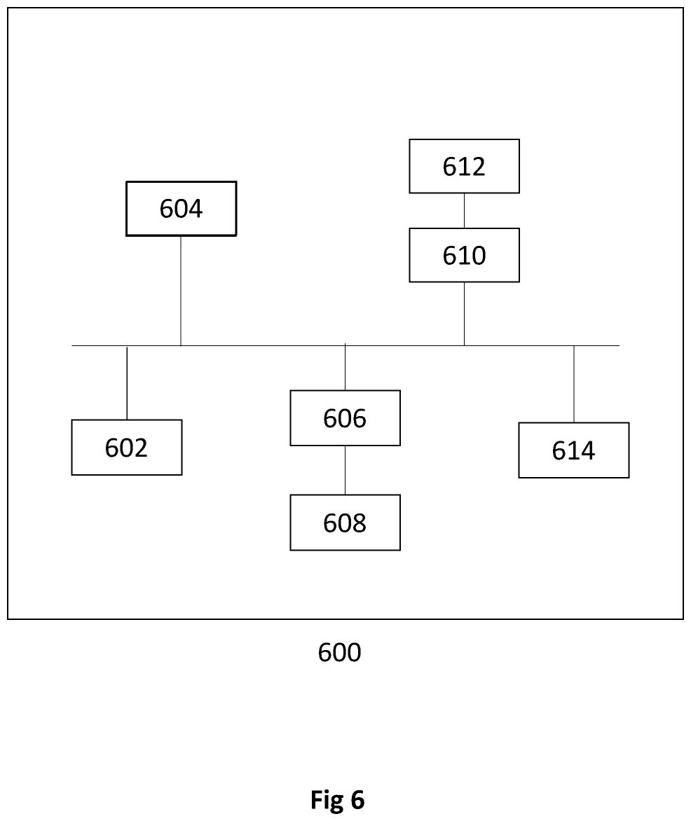

Turning finally to FIG. 6, FIG. 6 shows a schematic and simplified representation of a computer apparatus 600 which can be used to perform methods described herein, either alone, in combination with other computer apparatuses or as part of a network or a “cloud” computing arrangement.

The computer apparatus 600 comprises various data processing resources such as a processor 602 (in particular, a hardware processor) coupled to a central bus structure. Also connected to the bus structure are further data processing resources such as memory 604. A display adapter 606 connects a display device 608 to the bus structure. One or more user-input device adapters 610 connect a user-input device 612, such as a keyboard and/or a mouse to the bus structure. One or more communications adapters 614 are also connected to the bus structure to provide connections to other computer systems 600 and other networks.

In operation, the processor 602 of computer system 600 executes a computer program comprising computer-executable instructions that may be stored in memory 604. When executed, the computer-executable instructions may cause the computer system 600 to perform one or more of the methods described herein. The results of the processing performed may be displayed to a user via the display adapter 606 and display device 608. User inputs for controlling the operation of the computer system 600 may be received via the user-input device adapters 610 from the user-input devices 612.

It will be apparent that some features of computer system 600 shown in FIG. 6 may be absent in certain cases. For example, one or more of the plurality of computer apparatuses 600 may have no need for display adapter 606 or display device 608. This may be the case, for example, for particular server-side computer apparatuses 600 which are used only for their processing capabilities and do not need to display information to users. Similarly, user input device adapter 610 and user input device 612 may not be required. In its simplest form, computer apparatus 600 comprises processor 602 and memory 604.

The above detailed description describes a variety of example arrangements for and methods of performing distributed decryption. However, the described arrangements and methods are merely exemplary, and it will be appreciated by a person skilled in the art that various modifications can be made without departing from the scope of the appended claims.

More generally, it should be appreciated that the number of steps shown in the figures is not intended to be limiting. Steps may be repeated as often as necessary and certain steps may be omitted.

The computer apparatus discussed above may be a local computer or a server.

While various specific combinations of components and method steps have been described, these are merely examples. Components and method steps may be combined in any suitable arrangement or combination. Components and method steps may also be omitted to leave any suitable combination of components or method steps.

The described methods may be implemented using computer executable instructions. A computer program product or computer readable medium may comprise or store the computer executable instructions. The computer program product or computer readable medium may comprise a hard disk drive, a flash memory, a read-only memory (ROM), a CD, a DVD, a cache, a random-access memory (RAM) and/or any other storage media in which information is stored for any duration (e.g., for extended time periods, permanently, brief instances, for temporarily buffering, and/or for caching of the information). A computer program may comprise the computer executable instructions. The computer readable medium may be a tangible or non-transitory computer readable medium. The term “computer readable” encompasses “machine readable”.

In an implementation, the modules, components and other features described herein can be implemented as discrete components or integrated in the functionality of hardware components such as ASICS, FPGAs, DSPs or similar devices.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the disclosure. It will also be apparent that there are many variations that have not been described, but that fall within the scope of the appended claims.

The present disclosure also includes a number of further examples according to the following numbered clauses.

Clause 1. A computer-implemented method for distributed asymmetric decryption between a first party and a second party, each of the first and second parties holding a different respective share of a secret key, the method comprising:
receiving, at the second party: (i) a zero-knowledge proof of knowledge; and (ii) a plurality of inputs associated with a ciphertext to be decrypted, wherein the ciphertext is encrypted with a public key associated with the secret key;
checking, by the second party, that the zero-knowledge proof of knowledge was generated based on the first party's share of the secret key; and
in response to determining that the zero-knowledge proof of knowledge was generated based on the first party's share of the secret key, sending, by the second party, information derived from the second party's share of the secret key.

Clause 2. The method of Clause 1, wherein the information derived from the second party's share of the secret key is calculated by applying the second party's share of the secret key to an element of the ciphertext.

Clause 3. The method of Clause 2, wherein the ciphertext comprises at least three elements:
a first element, comprising a generator of a cyclic group raised to the power of a randomly generated number within the size of the cyclic group;
a second element, comprising an encryption of a plaintext based on the public key, a hashing function, and the randomly generated number;
a third element, comprising a non-interactive zero-knowledge proof of knowledge which is based on the randomly generated number.

Clause 4. The method of Clause 3, wherein the plurality of inputs associated with the ciphertext received at the second party comprise the first, second and third elements of the ciphertext.

Clause 5. The method of Clause 4, further comprising:
checking, at the second party, that the non-interactive zero-knowledge proof of knowledge pertains to the same randomly generated number as the first element and the second element of the ciphertext.

Clause 6. The method of Clause 5, wherein the non-interactive zero-knowledge proof of knowledge comprises:
a first value (α) based on the generator of the cyclic group and the randomly generated number; and
a second value (γ) based at least on the randomly generated number, a random hashing function, the generator of the cyclic group, the first value (α), and the first element of the ciphertext.

Clause 7. The method of Clause 6, wherein checking that the non-interactive zero-knowledge proof of knowledge pertains to the same randomly generated number as the first element and the second element of the ciphertext comprises:
computing, at the second party, a third value (β) by inputting: (i) the generator of the cyclic group, (ii) the first element of the ciphertext, (iii) the first value (α), and (iv) the second element of the ciphertext, into a random hashing function;
checking whether the generator of the cyclic group raised to the power of the second value (γ) equals a value obtained by multiplying the first value (α) by the first element of the ciphertext raised to the power of the computed third value (β).

Clause 8. The method of Clause 4, wherein the information derived from the second party's share of the secret key is calculated by raising the first element of the ciphertext to the power of the second party's share of the secret key.

Clause 9. The method of any preceding Clause, wherein checking that the zero-knowledge proof of knowledge was generated based on the first party's share of the secret key comprises:
computing, at the second party, a fourth value (β₁) by inputting: (i) the generator of the cyclic group, (ii) the first party's share of the public key, (iii) a fifth value (α₁) included in the received proof of knowledge, into a random hashing function;
checking whether the generator raised to the power of a received sixth value (γ₁) included in the received proof of knowledge, equals:
the product of the fifth value (α₁) included in the received proof of knowledge, multiplied by the first party's share of the public key raised to the power of the computed fourth value (β₁).

Clause 10. The method of Clause 9, wherein the computing of the fourth value (β₁) comprises further inputting: (iv) the first element of the ciphertext, (v) the second element of the ciphertext, and (vi) the third element of the ciphertext.

Clause 11. The method of Clause 3, wherein the plurality of inputs associated with the ciphertext received at the second party comprise:
a blinded version of the first element of the ciphertext, the blinded version obtained by secretly picking and applying an exponent to mask the first element of the ciphertext; and
a blinded proof obtained by malleating the non-interactive zero-knowledge proof of knowledge in the third element of the ciphertext.

Clause 12. The method of Clause 11, wherein malleating the proof in the third element of the ciphertext comprises secretly picking and applying one or more exponents to mask components of the proof.

Clause 13. The method of any of Clauses 11 or 12, wherein:
the blinded proof is a designated-verifier non-interactive zero-knowledge proof of knowledge, which is malleated using a proof creation key and can only be verified using a proof verification key paired with the proof creation key;
the second party holds the proof verification key paired with the proof creation key.

Clause 14. The method of any of Clauses 11-13, further comprising verifying, at the second party, the blinded proof.

Clause 15. The method of any preceding Clause, wherein determining that the zero-knowledge proof of knowledge was generated based on the first party's share of the secret key verifies that the first party's share of the secret key is compatible with the first party's share of the public key.

Clause 16. The method of any preceding Clause, wherein a first party's share of the public key is obtained by raising a generator of a cyclic group raised to the power of a value of the first party's share of the secret key.

Clause 17. The method according to any preceding Clause, further comprising blacklisting a party from which a zero-knowledge proof of knowledge was received, when it is determined that the zero knowledge proof of knowledge received from the party was not generated based on the first party's share of the secret key.

Clause 18. The method of Clause 17, wherein the party is blacklisted once a predetermined number of invalid zero-knowledge proofs of knowledge have been received from the party.

Clause 19. The method according to any preceding Clause, wherein the zero-knowledge proof of knowledge is a non-interactive zero-knowledge proof of knowledge.

Clause 20. The method according to any preceding Clause, further comprising:
generating, by the second party, a further zero-knowledge proof of knowledge, wherein the further zero-knowledge proof of knowledge is based on the second party's share of the secret key; and
sending the further zero-knowledge proof of knowledge with the information derived from the second party's share of the secret key.

Clause 21. The method of Clause 20, wherein second party's share of the public key is obtained by raising a generator of a cyclic group raised to the power of a value of the second party's share of the secret key.

Clause 22. The method of Clause 21 when dependent on Clause 4, wherein generating the further zero-knowledge proof of knowledge based on the second party's share of the secret key comprises:
generating, at the second party, a random number within the size of the cyclic group;
computing a seventh value (αᵤ) by raising the first element of the ciphertext to the power of the generated random number;
computing a eighth value (α_{g}) by raising the generator of the cyclic group to the power of the generated random number;
computing a ninth value (β₂) by inputting: (i) the first element of the ciphertext; (ii) the generator; (iii) the first element of the ciphertext raised to the power of the second party's share of the public key; (iv) the second party's share of the public key; (v) the seventh value (αᵤ); and (vi) the eighth value of (α_{g}), into a random hashing function;
computing a tenth value (γ₂) by multiplying the ninth value (β₂) by the value of the second party's share of the secret key and subsequently adding the generated random value to it;
wherein the seventh, eighth, ninth and tenth values comprise the further zero-knowledge proof of knowledge.

Clause 23. A network device configured for performing distributed asymmetric decryption with a client device holding a first share of a secret key, the network device comprising a memory storing a second share of the secret key, and being configured to:
receive, from a client device: (i) a zero-knowledge proof of knowledge; and (ii) a ciphertext to be decrypted, wherein the ciphertext is encrypted with a public key associated with the secret key;
check that the zero-knowledge proof of knowledge was generated based on the first share of the secret key; and
in response to determining that the zero-knowledge proof of knowledge was generated based on the first share of the secret key, send information derived from the second share of the secret key to the client device.

Clause 24. The network device according to Clause 23, further configured according to any of Clauses 2 to 22.

Clause 25. A computer readable medium, such as a non-transitory computer readable medium, having instructions stored thereon which when executed by a processor cause the processor to perform a method according to any of Clauses 1 through 22.

Clause 26. A computer-implemented method for distributed asymmetric decryption between a first party and a second party, each of the first and second parties holding a different respective share of a secret key, the method comprising:
generating, by the first party, a zero-knowledge proof of knowledge based on the first party's share of the secret key;
sending, by the first party: (i) the zero-knowledge proof of knowledge; and (ii) a plurality of inputs associated with a ciphertext to be decrypted, wherein the ciphertext is encrypted with a public key associated with the secret key;
receiving, at the first party, information derived from the second party's share of the secret key; and
generating, by the first party, a decryption of the ciphertext using the first party's share of the secret key and the received information.

Clause 27. The method of Clause 26, further comprising:
generating a first party share of the public key based on the first party's share of the secret key;
using the first party share of the public key to generate the zero-knowledge proof of knowledge; and
destroying the first party's share of the public key after use.

Clause 28. The method of Clause 26 or Clause 27, wherein the first party's share of the public key is generated responsive to receiving a request to decrypt the ciphertext and is destroyed after use.

Clause 29. The method according to any of Clauses 26 to 28, wherein generating the zero-knowledge proof of knowledge based on the first party's share of the secret key comprises generating two or more randomized values based on a generator of a cyclic group, the first party's share of the secret key, and the first party's share of the public key, using a randomly generated number and a random hashing function.

Clause 30. The method according to any of Clauses 26 to 29, wherein the information derived from the second party's share of the secret key comprises the result of an operation in which the second party's share of the secret key is applied to one of the plurality of inputs associated with the ciphertext.

Clause 31. The method according to any of Clauses 26 to 30, wherein the ciphertext comprises at least three elements:
a first element, comprising a generator of the cyclic group raised to the power of a randomly generated number within the size of the cyclic group;
a second element, comprising an encryption of a plaintext based on the public key, a hashing function, and the randomly generated number;
a third element, comprising a non-interactive zero-knowledge proof of knowledge which is based on the randomly generated number.

Clause 32. The method of Clause 31, wherein the inputs associated with the ciphertext sent by the first party comprise the first, second and third elements of the ciphertext.

Clause 33. The method of Clause 32, wherein the information derived from the second party's share of the secret key is calculated by raising the first element of the ciphertext to the power of the second party's share of the secret key.

Clause 34. The method of Clause 31, wherein the plurality of inputs associated with the ciphertext sent by the first party comprise:
a blinded version of the first element of the ciphertext, the blinded version obtained by secretly picking and applying an exponent to mask the first element of the ciphertext; and
a blinded proof obtained by malleating the non-interactive zero-knowledge proof of knowledge in the third element of the ciphertext.

Clause 35. The method of Clause 34, wherein malleating the proof in the third element of the ciphertext comprises secretly picking and applying one or more exponents to mask components of the proof.

Clause 36. The method of any of Clauses 34 or 35, wherein:
the blinded proof is a designated-verifier non-interactive zero-knowledge proof of knowledge, which is malleated using a proof creation key and can only be verified using a proof verification key paired with the proof creation key;
the second party holds the proof verification key paired with the proof creation key.

Clause 37. The method of any of Clauses 34-36, further comprising verifying, at the second party, the blinded proof.

Clause 38. The method according to any of Clauses 31-37, wherein generating the decryption of the ciphertext using the first party's share of the secret key and the received information comprises generating the decryption of the second element of the ciphertext using a hashing function, the first party's share of the secret key, and the received information.

Clause 39. The method according to any of Clauses 26 to 38, wherein a first party's share of the public key is obtained by raising a generator of a cyclic group raised to the power of a value of the first party's share of the secret key.

Clause 40. The method of Clause 39 when dependent on Clause 32, wherein generating the zero-knowledge proof of knowledge based on the first party's share of the secret key comprises:
generating, at the first party, a random number within the size of a cyclic group;
computing a fifth value (α₁) by raising a generator of the cyclic group to the power of the generated random number;
computing a fourth value (β₁) by inputting: (i) the generator, (ii) the first party's share of the public key, (iii) the fifth value (α₁), into a random hashing function;
computing a sixth value (γ₁) by multiplying the fourth value (β₁) by the value of the first party's share of the secret key and subsequently adding the generated random value to it;
wherein the fifth and sixth values comprise zero-knowledge proof of knowledge.

Clause 41. The method of Clause 40, wherein the computing of the fourth value (β₁) comprises further inputting: (iv) the first element of the ciphertext, (v) the second element of the ciphertext, and (vi) the third element of the ciphertext.

Clause 42. The method according to any of Clauses 26 to 41, wherein the zero-knowledge proof of knowledge is a non-interactive zero-knowledge proof of knowledge.

Clause 43. The method of any of Clauses 31-42, further comprising:
checking, at the first party, that the non-interactive zero-knowledge proof of knowledge pertains to the same randomly generated number as the first element and the second element of the ciphertext.

Clause 44. The method of Clause 43 when dependent on 32, wherein the non-interactive zero-knowledge proof of knowledge comprises:
a first value (α) based on the generator and the randomly generated number, and
a second value (γ) based at least on the randomly generated number, a random hashing function, the generator, the first value (α), and the first element of the ciphertext.

Clause 45. The method of Clause 44, wherein checking that the non-interactive zero-knowledge proof of knowledge pertains to the same randomly generated number as the first element and the second element of the ciphertext comprises:
computing, at the first party, a third value (β) by inputting: (i) the generator of the cyclic group, (ii) the first element of the ciphertext, (iii) the first value (α), and (iv) the second element of the ciphertext, into a random hashing function;
checking whether the generator of the cyclic group raised to the power of the second value (γ) equals a value obtained by multiplying the first value (α) by the first element of the ciphertext raised to the power of the computed third value (β).

Clause 46. The method according to any of Clauses 26-45, further comprising, before generating a decryption of the ciphertext using the first party's share of the secret key and the received information:
receiving, at the first party, a further zero-knowledge proof of knowledge; and
checking that the received further proof of knowledge pertains to the second party's share of the secret key.

Clause 47. The method of Clause 46 when dependent on 32, wherein the received zero-knowledge proof of knowledge comprises: (i) a seventh value (αᵤ), (ii) a eighth value (α_{g}), and (iii) a tenth value (β₂).

Clause 48. The method of Clause 47, wherein checking that the received proof of knowledge pertains to the second party's share of the secret key comprises:
computing, at the first party, a ninth value (β₂) by inputting: (i) the first element of the ciphertext; (ii) the generator; (iii) the first element of the ciphertext raised to the power of the second party's share of the public key; (iv) the second party's share of the public key; (v) the received seventh value (αᵤ); and (vi) the received eighth value (α_{g}), into a random hashing function;
checking, at the first party:
whether the first element of the ciphertext raised to the power of the received tenth value (γ₂) equals: the product of the received seventh value (αᵤ) multiplied by the second party's share of the public key raised to the power of the computed ninth value (β₂); and
whether the generator raised to the power of the received tenth value (γ₂), equals: the product of the received seventh value (αᵤ) multiplied by the second party's share of the public key raised to the power of the computed ninth value (β₂);
wherein the second party's share of the public key is derived from the public key and the first party's share of the public key.

Clause 49. A client device configured for performing distributed asymmetric decryption with a network device holding a second share of a secret key, the client device comprising a memory storing a first share of the secret key, and being configured to:
generate a zero-knowledge proof of knowledge based on the first share of the secret key;
send: (i) the zero-knowledge proof of knowledge; and (ii) a plurality of inputs associated with a ciphertext to be decrypted, wherein the ciphertext is encrypted with a public key associated with the secret key, to the network device;
receive information derived from the second share of the secret key from the network device; and
generate a decryption of the ciphertext using the first share of the secret key and the received information.

Clause 50. The client device of claim 49, further configured according to any of Clauses 27 to 48.

Clause 51. A computer readable medium, such as a non-transitory computer readable medium, having instructions stored thereon which when executed by a processor cause the processor to perform a method according to any of Clauses 26 through 48.

1. A computer-implemented method for distributed asymmetric decryption between a first party and a second party, each of the first and second parties holding a different respective share of a secret key, the method comprising:
receiving, at the second party: (i) a zero-knowledge proof of knowledge; and (ii) a plurality of inputs associated with a ciphertext to be decrypted, wherein the ciphertext is encrypted with a public key associated with the secret key;
checking, by the second party, that the zero-knowledge proof of knowledge was generated based on the first party's share of the secret key; and
in response to determining that the zero-knowledge proof of knowledge was generated based on the first party's share of the secret key, sending, by the second party, information derived from the second party's share of the secret key.

2. The method of claim 1, wherein the information derived from the second party's share of the secret key is calculated by applying the second party's share of the secret key to an element of the ciphertext.

3. The method of claim 2, wherein the ciphertext comprises at least three elements:
a first element, comprising a generator of a cyclic group raised to the power of a randomly generated number within the size of the cyclic group;
a second element, comprising an encryption of a plaintext based on the public key, a hashing function, and the randomly generated number;
a third element, comprising a non-interactive zero-knowledge proof of knowledge which is based on the randomly generated number.

4. The method of claim 3, wherein the plurality of inputs associated with the ciphertext received at the second party comprise the first, second and third elements of the ciphertext, the method further comprising checking, at the second party, that the non-interactive zero-knowledge proof of knowledge pertains to the same randomly generated number as the first element and the second element of the ciphertext.

5. (canceled)

6. The method of claim 4, wherein the non-interactive zero-knowledge proof of knowledge comprises:
a first value (α) based on the generator of the cyclic group and the randomly generated number; and
a second value (γ) based at least on the randomly generated number, a random hashing function, the generator of the cyclic group, the first value (α), and the first element of the ciphertext; and
wherein checking that the non-interactive zero-knowledge proof of knowledge pertains to the same randomly generated number as the first element and the second element of the ciphertext optionally comprises:
computing, at the second party, a third value (β) by inputting: (i) the generator of the cyclic group, (ii) the first element of the ciphertext, (iii) the first value (α), and (iv) the second element of the ciphertext, into a random hashing function;
checking whether the generator of the cyclic group raised to the power of the second value (γ) equals a value obtained by multiplying the first value (α) by the first element of the ciphertext raised to the power of the computed third value (β).

7. The method of claim 3, wherein the plurality of inputs associated with the ciphertext received at the second party comprise:
a blinded version of the first element of the ciphertext, the blinded version obtained by secretly picking and applying an exponent to mask the first element of the ciphertext; and
a blinded proof obtained by malleating the non-interactive zero-knowledge proof of knowledge in the third element of the ciphertext.

8. The method of claim 7, wherein malleating the proof in the third element of the ciphertext comprises secretly picking and applying one or more exponents to mask components of the proof; and/or
wherein the blinded proof is a designated-verifier non-interactive zero-knowledge proof of knowledge, which is malleated using a proof creation key and can only be verified using a proof verification key paired with the proof creation key; and the second party holds the proof verification key paired with the proof creation key;
the method optionally further comprising verifying, at the second party, the blinded proof.

9. The method of claim 1, further comprising blacklisting a party from which a zero-knowledge proof of knowledge was received, when it is determined that the zero knowledge proof of knowledge received from the party was not generated based on the first party's share of the secret key.

10. A network device configured for performing distributed asymmetric decryption with a client device holding a first share of a secret key, the network device comprising a memory storing a second share of the secret key, and being configured to perform the steps:
receiving, at the network device: (i) a zero-knowledge proof of knowledge; and (ii) a plurality of inputs associated with a ciphertext to be decrypted, wherein the ciphertext is encrypted with a public key associated with the secret key;
checking, by the network device, that the zero-knowledge proof of knowledge was generated based on the client device's share of the secret key; and
in response to determining that the zero-knowledge proof of knowledge was generated based on the client device's share of the secret key, sending, by the network device, information derived from the second party's share of the secret key.

11. (canceled)

12. A computer-implemented method for distributed asymmetric decryption between a first party and a second party, each of the first and second parties holding a different respective share of a secret key, the method comprising:
generating, by the first party, a zero-knowledge proof of knowledge based on the first party's share of the secret key;
sending, by the first party: (i) the zero-knowledge proof of knowledge; and (ii) a plurality of inputs associated with a ciphertext to be decrypted, wherein the ciphertext is encrypted with a public key associated with the secret key;
receiving, at the first party, information derived from the second party's share of the secret key; and
generating, by the first party, a decryption of the ciphertext using the first party's share of the secret key and the received information.

13. The method of claim 12, further comprising:
generating a first party share of the public key based on the first party's share of the secret key;
using the first party share of the public key to generate the zero-knowledge proof of knowledge; and
destroying the first party's share of the public key after use.

14. The method of claim 11, wherein the first party's share of the public key is generated responsive to receiving a request to decrypt the ciphertext and is destroyed after use.

15. The method according to claim 11, wherein generating the zero-knowledge proof of knowledge based on the first party's share of the secret key comprises generating two or more randomized values based on a generator of a cyclic group, the first party's share of the secret key, and the first party's share of the public key, using a randomly generated number and a random hashing function.

16. The method according to claim 11, wherein the ciphertext comprises at least three elements:
a first element, comprising a generator of the cyclic group raised to the power of a randomly generated number within the size of the cyclic group;
a second element, comprising an encryption of a plaintext based on the public key, a hashing function, and the randomly generated number;
a third element, comprising a non-interactive zero-knowledge proof of knowledge which is based on the randomly generated number.

17. The method of claim 16, wherein the inputs associated with the ciphertext sent by the first party comprise the first, second and third elements of the ciphertext, and wherein the information derived from the second party's share of the secret key is calculated by raising the first element of the ciphertext to the power of the second party's share of the secret key.

18. (canceled)

19. The method of claim 16, wherein the plurality of inputs associated with the ciphertext sent by the first party comprise:
a blinded version of the first element of the ciphertext, the blinded version obtained by secretly picking and applying an exponent to mask the first element of the ciphertext; and
a blinded proof obtained by malleating the non-interactive zero-knowledge proof of knowledge in the third element of the ciphertext.

20. The method of claim 19, wherein malleating the proof in the third element of the ciphertext comprises secretly picking and applying one or more exponents to mask components of the proof; and/or
wherein the blinded proof is a designated-verifier non-interactive zero-knowledge proof of knowledge, which is malleated using a proof creation key and can only be verified using a proof verification key paired with the proof creation key; and the second party holds the proof verification key paired with the proof creation key;
wherein the method further comprises verifying, at the second party, the blinded proof.

21. The method according to claim 12, wherein generating the decryption of the ciphertext using the first party's share of the secret key and the received information comprises generating the decryption of the second element of the ciphertext using a hashing function, the first party's share of the secret key, and the received information.

22. The method according to claim 12, further comprising:
checking, at the first party, that the non-interactive zero-knowledge proof of knowledge pertains to the same randomly generated number as the first element and the second element of the ciphertext.

23. A client device configured for performing distributed asymmetric decryption with a network device holding a second share of a secret key, the client device comprising a memory storing a first share of the secret key, and being configured to perform the steps:
generating, by the client device, a zero-knowledge proof of knowledge based on the client device's share of the secret key;
sending, by the client device: (i) the zero-knowledge proof of knowledge; and (ii) a plurality of inputs associated with a ciphertext to be decrypted, wherein the ciphertext is encrypted with a public key associated with the secret key;
receiving, at the client device, information derived from the network device's share of the secret key; and
generating, by the client device, a decryption of the ciphertext using the client device's share of the secret key and the received information.

24. (canceled)

25. (canceled)
